(19) United States
(12) Patent Application Publication
(10) Pub. No.: US 2024/0198755 A1
(43) Pub. Date: Jun. 20, 2024

(54) VEHICLE COOLER

(71) Applicants: TOYOTA JIDOSHA KABUSHIKI KAISHA, Toyota-shi Aichi-ken (JP); SUBARU CORPORATION, Shibuya-ku Tokyo (JP)

(72) Inventor: Hironobu SAKAMOTO, okazaki-shi (JP)

(73) Assignees: TOYOTA JIDOSHA KABUSHIKI KAISHA, Toyota-shi Aichi-ken (JP); SUBARU CORPORATION, Shibuya-ku Tokyo (JP)

(21) Appl. No.: 18/543,684

(22) Filed: Dec. 18, 2023

(30) Foreign Application Priority Data
Dec. 20, 2022 (JP) 2022-202822

(51) Int. Cl. B60H 1/00; B60H 1/32

(52) U.S. Cl. CPC B60H 1/00278; B60H 1/00328; B60H 1/3204; B60H 2001/2271

(57) ABSTRACT

A vehicle cooler is configured to cool a drive unit that drives a vehicle and a battery that supplies electric power to the drive unit. The vehicle cooler includes a cooling channel that connects the drive unit and the battery in series to allow the refrigerant to flow through the drive unit and the battery. The battery is connected downstream of the drive unit.

### CROSS REFERENCE TO RELATED APPLICATION

This application claims priority to Japanese Patent Application No. 2022-202822 filed on Dec. 20, 2022, which is incorporated herein by reference in its entirety including the specification, claims, drawings, and abstract.

### TECHNICAL FIELD

The present disclosure relates to a structure and control of a vehicle cooler.

### BACKGROUND

Methods for raising a battery temperature for charging the battery have been proposed. JP 2019-89524 A, for example, discloses driving a heater and a fan with battery power prior to start of charging of the battery, raising the battery temperature with heat generated by discharging of the battery and hot air from the heater and the fan, and then starting charging of the battery in a temperature-raised state.

JP 2020-195253 A discloses a method including distributing a charging power supplied to a vehicle from an external charging facility to a battery and a battery heater at a predetermined distribution ratio and, in response to a temperature rise rate of the battery being lower than a predetermined value, controlling to increase the distribution ratio to the heater and raising the battery temperature and charging the battery.

### SUMMARY

An electrically-driven vehicle includes a cooler for cooling a drive unit that drives the vehicle. While effective use by the cooler of heat generated from the drive unit has been studied in recent years, such an effective use of heat has not been sufficiently achieved.

An embodiment of a vehicle cooler according to the present disclosure is therefore aimed at effective use of heat generated from a drive unit of a vehicle.

A vehicle cooler according to the disclosure is configured to cool a drive unit that drives a vehicle and a battery that supplies electric power to the drive unit. The vehicle cooler includes a cooling channel connecting the drive unit and the battery in series to allow a refrigerant to flow through the drive unit and the battery, and the battery is connected downstream of the drive unit.

This configuration enables a temperature rise of the battery with heat generated by the drive unit to achieve effective use of the heat generated from the drive unit. This configuration further enables a temperature rise of the battery, when the battery temperature is low, to thereby increase charge and discharge efficiency of the battery.

In the vehicle cooler, the drive unit may include a motor for vehicle driving and a power control unit configured to regulate electric power to be supplied to the motor.

This configuration enables use of the heat generated by the motor and the power controller for a temperature rise of the battery in an electric motor vehicle, to thereby increase the power efficiency of the electric motor vehicle.

The vehicle cooler may further include a first bypass channel connected to the cooling channel to allow the refrigerant to flow through the battery while bypassing the drive unit, a first switching valve configured to switchably allow the refrigerant to pass through the first bypass channel or through the drive unit, an air-conditioner configured to air-condition a vehicle cabin, a heat exchanger configured to perform heat exchange with the air-conditioner to heat the refrigerant flowing through the cooling channel, and a controller configured to adjust operation of the first switching valve, the air-conditioner, and the drive unit. In response to a temperature of the drive unit being lower than a first predetermined temperature, the controller may be configured to switch the first switching valve to allow the refrigerant to flow through the first bypass channel, and drive the air-conditioner to heat the refrigerant by the air-conditioner and the heat exchanger to raise a temperature of the battery with the refrigerant that is heated.

This configuration allows the heat from the air-conditioner to flow into the battery and prevents the heat from the air-conditioner from flowing into the drive unit when the temperatures of the battery and the drive unit are low. This enables a temperature rise of the battery with the heat of the air-conditioner when the temperature of the drive unit is low.

In the vehicle cooler, in response to the temperature of the drive unit being equal to or higher than the first predetermined temperature, the controller may be configured to switch the first switching valve to allow the refrigerant to flow through the drive unit and drive the air-conditioner, and the drive unit to heat the refrigerant by the air-conditioner, the heat exchanger, and the drive unit to raise the temperature of the battery with the refrigerant that is heated.

This configuration enables use of the heat generated by the drive unit for a temperature rise of the battery.

The vehicle cooler may include a second bypass channel connected between the drive unit and the battery to allow the refrigerant to flow while bypassing the battery, a second switching valve configured to switchably allow the refrigerant to flow through the battery or through the second bypass channel, an air-conditioner configured to air-condition a vehicle cabin, a heat exchanger configured to perform heat exchange with the air-conditioner to heat the refrigerant flowing through the cooling channel, and a controller configured to adjust operation of the second switching valve, the air-conditioner, and the drive unit. In response to the temperature of the drive unit being lower than a second predetermined temperature while the vehicle is stopped, the controller may be configured to switch the second switching valve to allow the refrigerant to flow through the second bypass channel, and drive the air-conditioner to heat the refrigerant by the air-conditioner and the heat exchanger to raise the temperature of the drive unit with the refrigerant that is heated.

This configuration enables a temperature rise of the battery in a short time.

In the vehicle cooler, the drive unit, the air-conditioner, and the heat exchanger may be housed within a front compartment of the vehicle. The vehicle cooler may include a grille shutter configured to open or close an opening of the front compartment. In response to the temperature of the drive unit being lower than the second predetermined temperature while the vehicle is stopped, the controller may be configured to close the grille shutter.

This configuration enables a temperature rise of the drive unit housed within the front compartment in a short time and enables a temperature rise of the battery with the heat from the drive unit in a short time.

In the vehicle cooler, in response to the temperature of the drive unit being equal to or higher than the second predetermined temperature, the controller may be configured to switch the second switching valve to allow the refrigerant to flow through the battery, and drive the air-conditioner, and the drive unit to heat the refrigerant by the air-conditioner, the heat exchanger, and the drive unit, to raise the temperature of the battery with the refrigerant that is heated.

This configuration enables a temperature rise of the battery with the heat generated by the drive unit and the heat from the air-conditioner.

In the vehicle cooler, the cooling channel may include a drive unit return channel that allows the refrigerant to return to the drive unit, and a battery return channel that allows the refrigerant to return to the battery. The vehicle cooler may further include a third switching valve configured to switch a connection mode regarding connection of the drive unit return channel and the battery return channel, between a serial connection mode in which the drive unit and the battery are connected in series, with the battery being downstream of the drive unit, to allow the refrigerant to flow through the drive unit and the battery, and a channel separation mode in which the battery return channel and the drive unit return channel are separated, an air-conditioner configured to air-condition a vehicle cabin, a heat exchanger that performs heat exchange with the air-conditioner to heat the refrigerant that flows through the cooling channel, and a controller configured to adjust operation of the air-conditioner and the drive unit. In response to a remaining capacity of the battery being equal to or lower than a predetermined capacity during traveling of the vehicle, the controller may be configured to switch the third switching valve to the serial connection mode, drive the air-conditioner and heat the refrigerant by the air-conditioner, the heat exchanger, and the drive unit, and raise the temperature of the battery with the refrigerant that is heated.

This configuration enables a temperature rise of the battery during traveling of the vehicle. This enables rapid charging immediately after stopping of the vehicle.

In the vehicle cooler, the drive unit, the air-conditioner, and the heat exchanger may be housed within a front compartment of the vehicle. The vehicle cooler may include a grille shutter configured to open or close an opening of the front compartment. The controller may be configured to calculate a temperature difference between the temperature of the drive unit and a cooling start temperature at which cooling of the drive unit is necessary, and close the grille shutter in response to the temperature difference being equal to or higher than a predetermined threshold value.

This configuration enables a temperature rise of the drive unit housed within the front compartment in a short time and enables a temperature rise of the battery with the heat from the drive unit.

In the vehicle cooler, the cooling channel may include a drive unit return channel that allows the refrigerant to return to the drive unit, and a battery return channel that allows the refrigerant to return to the battery. The vehicle cooler may further include a third switching valve configured to switch a connection mode regarding connection of the drive unit return channel and the battery return channel, between a serial connection mode in which the drive unit and the battery are connected in series, with the battery being downstream of the drive unit, to allow the refrigerant to flow through the drive unit and the battery, and a channel separation mode in which the battery return channel and the drive unit return channel are separated, and a controller configured to adjust operation of the third switching valve. The controller may be configured to switch the third switching valve to the serial connection mode to constitute the cooling channel that connects the drive unit and the battery in series.

This configuration enables switching of the cooling channel in accordance with the temperatures of the drive unit and the battery.

In the vehicle cooler, the cooling channel may include a drive unit return channel that allows the refrigerant to return to the drive unit, and a battery return channel that allows the refrigerant to return to the battery. The vehicle cooler may further include a third switching valve configured to switch a connection mode regarding connection of the drive unit return channel and the battery return channel, between a serial connection mode in which the drive unit and the battery are connected in series, with the battery being downstream of the drive unit, to allow the refrigerant to flow through the drive unit and the battery, and a channel separation mode in which the battery return channel and the drive unit return channel are separated. The controller may be configured to adjust operation of the third switching valve. The controller may be configured to switch the third switching valve to the serial connection mode to form the cooling channel in which the drive unit and the battery are connected in series.

This configuration enables switching of the cooling channel in accordance with the temperatures of the drive unit and the battery.

The vehicle cooler of the present disclosure enables effective use of the heat generated by the drive unit of a vehicle.

### BRIEF DESCRIPTION OF DRAWINGS

Embodiments of the present disclosure will be described based on the following figures, wherein:

FIG. 1 is a system diagram illustrating a configuration of a vehicle cooler according to an embodiment;

FIG. 2 is a lateral cross sectional view of a vehicle including the vehicle cooler according to the embodiment;

FIG. 3 is an explanatory view showing connection modes of a five-way valve used in the vehicle cooler according to the embodiment and switching of the connection modes;

FIG. 4 is a system diagram illustrating operation of the vehicle cooler while a vehicle is traveling in a low temperature environment with a vehicle cabin being heated;

FIG. 5 is a system diagram illustrating operation of the vehicle cooler immediately after activation of a vehicle in a low temperature environment and start of vehicle traveling with a vehicle cabin being heated;

FIG. 6 is a system diagram illustrating operation of the vehicle cooler in response to a drive unit having a first predetermined temperature or higher after activation of a vehicle in a low temperature environment and start of vehicle traveling with a vehicle cabin being heated;

FIG. 7 is a flowchart showing operation of the vehicle cooler when a vehicle is activated in a low temperature environment and is traveling with a vehicle cabin being heated;

FIG. 8 indicates, in a top view, changes with time of the drive unit temperature and the battery water temperature and, in a bottom view, changes with time of amounts of heat transferred from a warming heater, a battery heater, and a heat pump circuit, and a drive unit to the battery, when a vehicle is activated in a low temperature environment and travels while heating the interior of a vehicle cabin.

FIG. 9 indicates a breakdown of the amount of heat transferred to the battery at time t1 and time t3 shown in FIG. 8;

FIG. 10 is a system diagram illustrating operation of the vehicle cooler at time of heating of a vehicle cabin and a temperature rise of the battery when a vehicle is stopped after activated in a low temperature environment;

FIG. 11 is a flowchart indicating operation of the vehicle cooler at time of heating of a vehicle cabin and a temperature rise of the battery when a vehicle is stopped after being activated in a low temperature environment;

FIG. 12 is a flowchart continued from the flowchart in FIG. 11;

FIG. 13 indicates, in a top view, changes with time of the drive unit temperature, the battery water temperature, the heating medium temperature, and the front compartment atmosphere temperature, and, in a bottom view, changes with time of amounts of heat transferred from a warming heater, a battery heater, a heat pump circuit, and a drive unit to a refrigerant, at the time of heating of a vehicle cabin and a temperature rise of the battery when a vehicle is stopped after being activated in a low temperature environment;

FIG. 14 is a flowchart showing operation of the vehicle cooler at time of preheating of the battery during traveling of a vehicle in a low temperature environment; and

FIG. 15 is a flowchart continued from the flowchart in FIG. 14.

### DESCRIPTION OF EMBODIMENTS

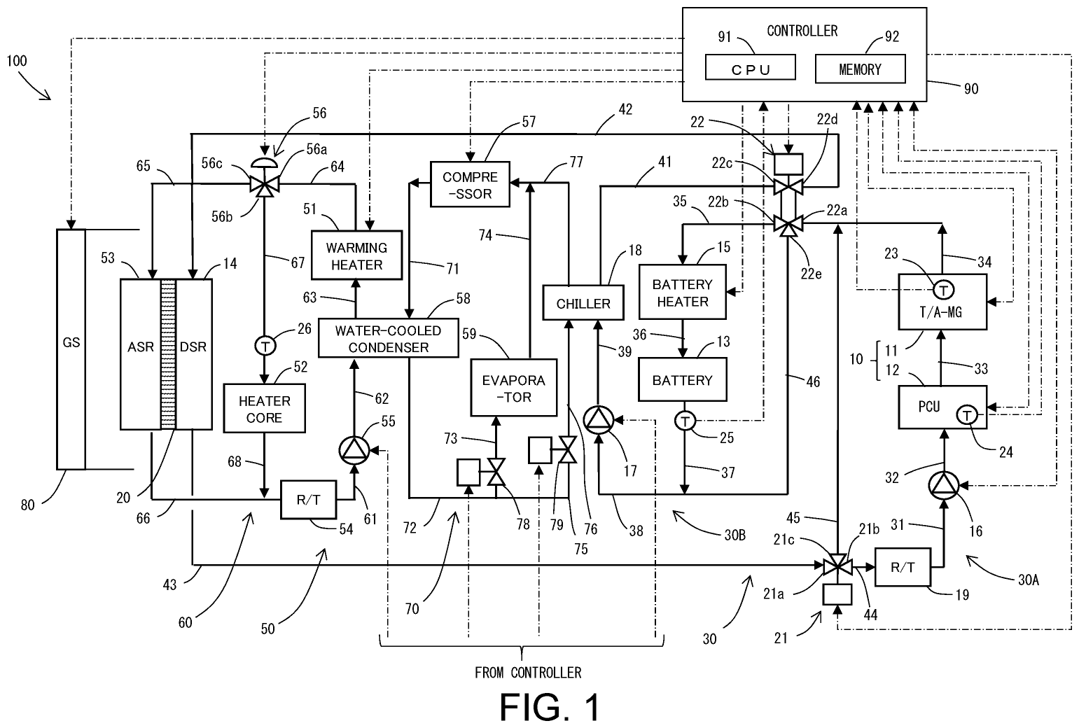

A vehicle cooler 100 according to an embodiment will be described by reference to the drawings. As illustrated in FIG. 1, the vehicle cooler 100 is an apparatus that cools a drive unit 10 and a battery 13. The vehicle cooler 100 includes a cooling channel 30, a drive unit bypass channel 45, a battery bypass channel 46, an air-conditioning unit 50, a grille shutter (GS) 80, and a controller 90. The drive unit 10 includes a motor device 11 and a power control unit 12 (hereinafter referred to as a “PCU 12”).

The cooling channel 30 allows a refrigerant to pass through the drive unit 10 and the battery 13. The cooling channel 30 includes a water pump 16 adjacent the drive unit 10, which will be hereinafter referred to as “drive unit-side water pump 16”, the PCU 12, the motor device 11, a battery heater 15, the battery 13, a water pump 17 adjacent the battery 13, which will be hereinafter referred to as “battery-side water pump 17”, a chiller 18, a driving system radiator (DSR) 14, a reservoir tank 19, a three-way valve 21, a five-way valve 22, and pipes connecting these devices.

The drive unit-side water pump 16 boosts the refrigerant flowing through the cooling channel 30. The refrigerant may be cooling water such as LCC. The motor device 11 is an assembly of a vehicle driving motor and a transaxle. The motor device 11 includes an inner channel (not shown) through which refrigerant flows through to cool the motor device 11. A motor temperature sensor 23 is mounted on the motor device 11 to detect a motor coil temperature, for example. The PCU 12 is a device that regulates power to be supplied to the vehicle driving motor, and may include a boost converter and an inverter. The PCU 12 also includes an inner channel (not shown) through which the refrigerant flows through to cool the PCU 12. A PCU temperature sensor 24 is mounted on the PCU 12 to detect the temperature of the refrigerant flowing through the inner channel. The battery heater 15 heats the refrigerant flowing through an inner channel (not shown) and raises the temperature of the battery 13 with the heated refrigerant. The battery 13 supplies power to the vehicle driving motor. The battery 13, similar to the PCU 12, includes an inner channel (not shown) through which the refrigerant flows through to cool the battery 13. The battery-side water pump 17 boosts the refrigerant flowing through the cooling channel 30. The chiller 18 is disposed to bridge between a heat pump circuit 70 that will be described below, and the cooling channel 30, and is a heat exchanger that performs heat exchange between refrigerant gas flowing in the heat pump circuit 70 and the refrigerant flowing in the cooling channel 30. The driving system radiator (DSR) 14 includes an inner channel (not shown) through which the refrigerant flows, and performs heat exchange between the refrigerant and the outside air to cool the refrigerant. The reservoir tank 19 stores the refrigerant to be supplied to the drive unit-side water pump 16.

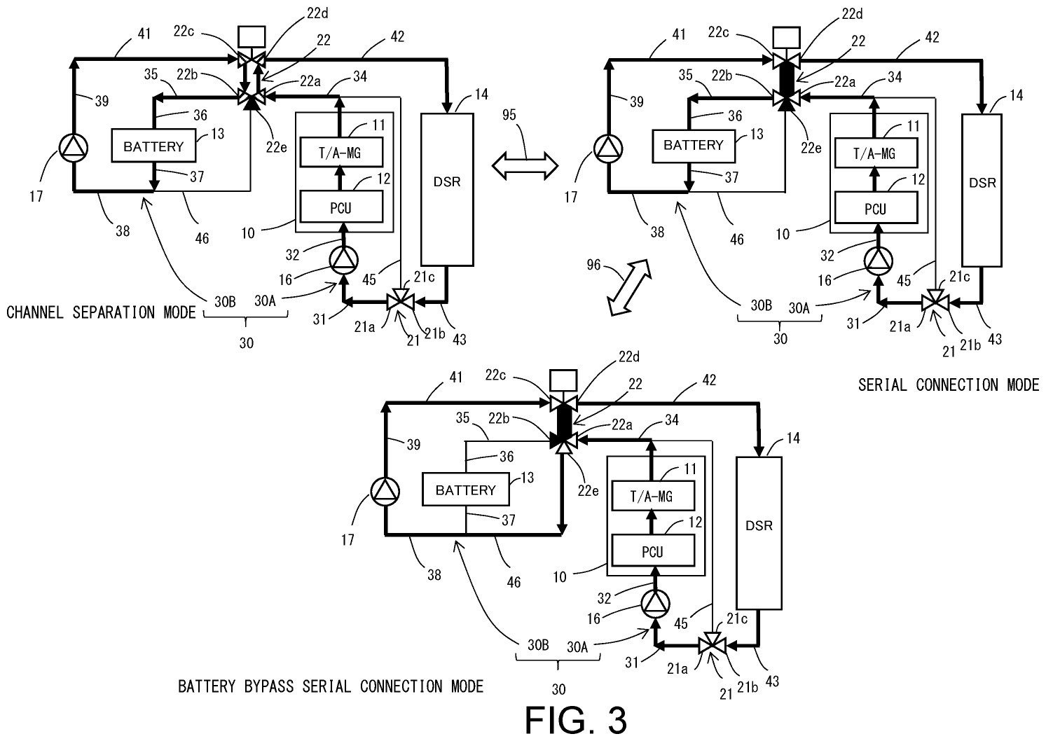

The three-way valve 21 is connected between the reservoir tank 19 and the driving system radiator (DSR) 14, and includes three ports: a first port 21a, a second port 21b, and a third port 21c. The first port 21a is a refrigerant inlet, and the second port 21b and the third port 21c are refrigerant outlets. The three-way valve 21 is a first switching valve that switches the outlets of the refrigerant flow from the first port 21a between the second port 21b and the third port 21c. The five-way valve 22 is connected between the motor device 11 and the battery heater 15, and between the chiller 18 and the driving system radiator (DSR) 14. The five-way valve 22 includes five ports including a first port 22a to a fifth port 22e, which are switchable among various connection modes. The connection modes of the five-way valve 22 will be described below by reference to FIG. 3. The five-way valve 22 constitutes a second switching valve or a third switching valve in accordance with the connection mode.

The pipes connecting the devices of the cooling channel 30 include a drive-unit-side pump outlet pipe 32, a PCU outlet pipe 33, a motor device outlet pipe 34, a battery heater inlet pipe 35, a battery heater outlet pipe 36, a battery outlet pipe 37, a battery-side water pump inlet pipe 38, a battery-side water pump outlet pipe 39, a chiller outlet pipe 41, a driving system radiator inlet pipe 42, a driving system radiator outlet pipe 43, a reservoir tank inlet pipe 44, and a drive-unit-side pump inlet pipe 31.

The drive unit-side pump outlet pipe 32 connects an outlet of the drive unit-side water pump 16 and an inlet of the inner channel of the PCU 12. The PCU outlet pipe 33 connects an outlet of the inner channel of the PCU 12 and an inlet of the inner channel of the motor device 11. The motor device outlet pipe 34 connects the inner channel of the motor device 11 and the first port 22a of the five-way valve 22. The battery heater inlet pipe 35 connects the second port 22b of the five-way valve 22 and an inlet of the inner channel of the battery heater 15. The battery heater outlet pipe 36 connects an outlet of the inner channel of the battery heater 15 and an inlet of the inner channel of the battery 13. The battery outlet pipe 37 connects an outlet of the inner channel of the battery 13 and an upper end of the battery-side water pump 17. A battery water-temperature sensor 25 is mounted on the battery outlet pipe 37 to detect the refrigerant temperature at the outlet of the battery 13. The battery-side water pump inlet pipe 38 has a downstream end that is connected to an inlet of the battery-side water pump 17. The battery-side water pump outlet pipe 39 connects an outlet of the battery-side water pump 17 and an inlet of the refrigerant inner channel of the chiller 18. The chiller outlet pipe 41 connects an outlet of a refrigerant inner channel of the chiller 18 and the third port 22c of the five-way valve 22. The driving system radiator inlet pipe 42 connects the fourth port 22d of the five-way valve 22 and an inlet of the inner channel of the driving system radiator (DSR) 14. The driving system radiator outlet pipe 43 connects an outlet of the inner channel of the driving system radiator (DSR) 14 and the first port 21a of the three-way valve 21. The reservoir tank inlet pipe 44 connects the second port 21b of the three-way valve 21 and the reservoir tank 19. The drive unit-side pump inlet pipe 31 connects the reservoir tank 19 and an inlet of the drive unit-side water pump 16.

The drive unit bypass channel 45 connects the third port 21c of the three-way valve 21 and the motor device outlet pipe 34. The drive unit bypass channel 45 allows the refrigerant to flow through the battery 13 while bypassing the drive unit. The drive unit bypass channel 45 constitutes a first bypass channel.

The battery bypass channel 46 connects the fifth port 22e of the five-way valve 22 and an upstream end of the battery-side water pump inlet pipe 38. The battery bypass channel 46 is connected between the drive unit 10 and the battery 13, and allows the refrigerant to flow through while bypassing the battery 13. The battery bypass channel 46 constitutes a second bypass channel.

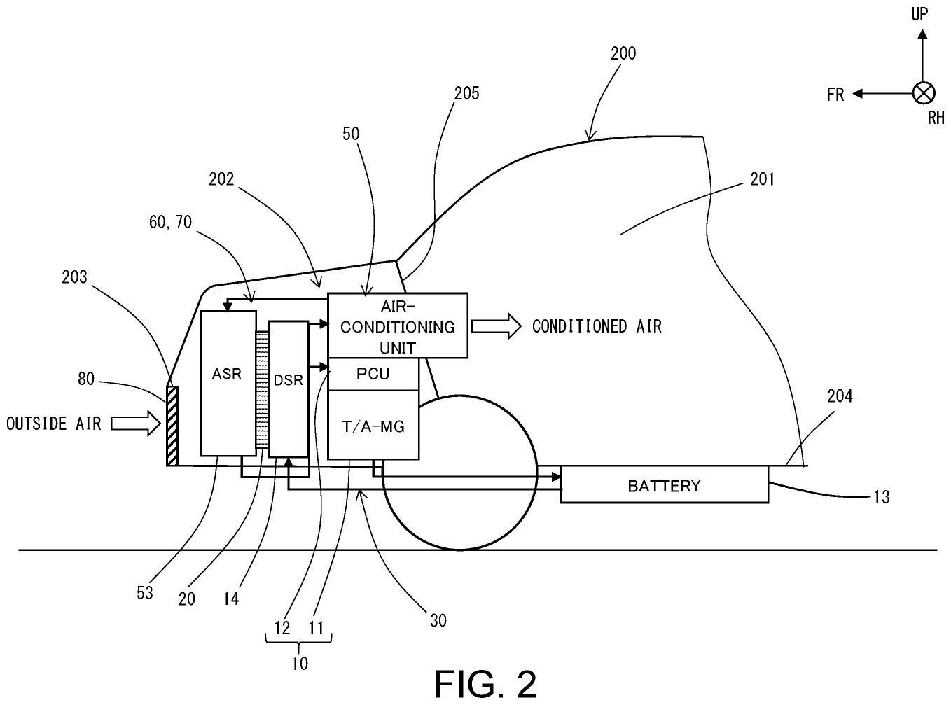

The air-conditioning unit 50 includes a heater circuit 60 and the heat pump circuit 70. The heater circuit 60 heats a heating medium with a warming heater 51 to heat a vehicle cabin 201 (see FIG. 2). The heat pump circuit 70 compresses the heating medium with a compressor 57 to cool or heat the vehicle cabin 201. To cool the vehicle cabin 201 with the heat pump circuit 70, the heater circuit 60 operates to externally discharge heat of high-temperature refrigerant gas flowing through the heat pump circuit 70.

The heater circuit 60 includes a water pump adjacent the heater, which will hereinafter be referred to as a “heater-side water pump” 55, a water-cooled condenser 58, the warming heater 51, a heater core 52, a reservoir tank 54, an air-conditioning system radiator (ASR) 53, a three-way control valve 56, and pipes for connecting these devices.

The heater-side water pump 55 boosts the heating medium flowing in the heater circuit 60. The heating medium may be cooling water. The water-cooled condenser 58 is a heat exchanger disposed to bridge between the heater circuit 60 and the heat pump circuit 70 which will be described below, to perform heat exchange between the heating medium flowing in the heater circuit 60 and the refrigerant gas flowing in the heat pump circuit 70. The water-cooled condenser 58 includes an inner channel (not shown) through which the heating medium flows and an inner channel (now shown) through which the refrigerant gas flows. The warming heater 51 includes an electric heater that operates with power supplied from the battery 13, and an inner channel (now shown) through which the heating medium flows. The warming heater 51 heats the heating medium that flows through the inner channel (now shown) with the electric heater. The heater core 52 includes an inner channel through which the heating medium flows, and allows the heated heating medium to flow through the inner channel to thereby raise the temperature of the outside air and feed the hot air to the vehicle cabin 201. The reservoir tank 54 stores the heating medium.

The air-conditioning system radiator (ASR) 53 includes an inner channel (not shown) through which the heating medium flows, and performs heat exchange between the heating medium and the outside air to cool the heating medium. The air-conditioning system radiator (ASR) 53 and the driving system radiator (DSR) 14 are connected through a heat-conductive member 20 to enable heat transfer therebetween. The three-way control valve 56 includes three ports: a first port 56a, a second port 56b, and a third port 56c. The first port 56a is a heating medium inlet, and the second port 56b and a third port 56c are heating medium outlets. The three-way control valve 56 regulates the ratio of the flow rates of the heating medium from the first port 56a out through the second port 56b and through the third port 56c. The three-way control valve 56 switches between a radiator separation mode and a radiator block mode. The radiator separation mode refers to a control mode which allows the heating medium flowing from the first port 56a to flow through the second port 56b and the third port 56c at a predetermined ratio. The radiator block mode refers to a mode to block the heating medium flowing to the air-conditioning system radiator (ASR) 53 by setting the ratio of the flow-out rate of the heating medium from the second port 56b of the three-way control valve 56 and the flow-out rate of the heating medium from the third port 56c of the three-way control valve 56 to 100:0.

The pipes connecting the devices of the heater circuit 60 include a heater-side pump outlet pipe 62, a water-cooled condenser outlet pipe 63, a warming heater outlet pipe 64, an air-conditioning system radiator inlet pipe 65, an air-conditioning system radiator outlet pipe 66, a heater-side pump inlet pipe 61, a heater core inlet pipe 67, and a heater core outlet pipe 68.

The heater-side pump outlet pipe 62 connects an outlet of the heater-side water pump 55 and an inlet of the inner channel of the water-cooled condenser 58 through which the heating medium flows. The water-cooled condenser outlet pipe 63 connects an outlet of the inner channel of the water-cooled condenser 58 through which heating medium flows and an inlet of the inner channel of the warming heater 51. The warming heater outlet pipe 64 connects an outlet of the inner channel of the warming heater 51 and the first port 56a of the three-way control valve 56. The air-conditioning system radiator inlet pipe 65 connects the third port 56c of the three-way control valve 56 and an inlet of the inner channel of the air-conditioning system radiator (ASR) 53. The air-conditioning system radiator outlet pipe 66 connects an outlet of the inner channel of the air-conditioning system radiator (ASR) 53 and the reservoir tank 54. The heater-side pump inlet pipe 61 connects the reservoir tank 54 and an inlet of the heater-side water pump 55. The heater core inlet pipe 67 connects the second port 56b of the three-way control valve 56 and an inlet of the inner channel of the heater core 52. A heater core inlet water-temperature sensor 26 is mounted on the heater core inlet pipe 67 to detect the temperature of the heating medium at the inlet of the heater core 52.

The heat pump circuit 70 includes the compressor 57, the water-cooled condenser 58, an evaporator 59, the chiller 18, an expansion valve adjacent the evaporator, which will be referred to as an “evaporator-side expansion valve”, 78, an expansion valve adjacent to the chiller, which will be referred to as a “chiller-side expansion valve” 79, and pipes connecting these devices.

The compressor 57 compresses refrigerant gas flowing through the heat pump circuit 70. The water-cooled condenser 58 includes an inner channel (not shown) through which the refrigerant gas flows, and performs heat exchange between the high-temperature compressed refrigerant gas and the heating medium flowing through the heater circuit 60 to thereby cool the refrigerant gas and also heat the heating medium. The evaporator-side expansion valve 78 decompresses and expands the high-pressure and low-temperature liquid refrigerant gas. The evaporator 59 performs heat exchange between the liquid refrigerant gas and the outside air to cool the outside air and supplies cooling air to the vehicle cabin 201. The refrigerant gas evaporates into gas due to heat exchange. The chiller-side expansion valve 79, similar to the evaporator-side expansion valve 78, decompresses and expands the high-pressure and low-temperature liquid refrigerant gas. The chiller 18 includes an inner channel (not shown) through which the refrigerant gas flows, and performs heat exchange between the expanded low-temperature refrigerant gas and the refrigerant flowing through the cooling channel 30 to cool the refrigerant flowing through the cooling channel 30.

The pipes connecting the devices of the heat pump circuit 70 include a compressor outlet pipe 71, a water-cooled condenser outlet pipe 72, an evaporator-side expansion valve outlet pipe 73, an evaporator outlet pipe 74, a chiller-side expansion valve inlet pipe 75, a chiller-side expansion valve outlet pipe 76, and a chiller outlet pipe 77.

The compressor outlet pipe 71 connects a refrigerant gas outlet of the compressor 57 and an inlet of an inner channel (not shown) of the water-cooled condenser 58 through which the refrigerant gas flows. The water-cooled condenser outlet pipe 72 connects an outlet of the inner channel of the water-cooled condenser 58 through which the refrigerant gas flows and the evaporator-side expansion valve 78. The chiller-side expansion valve inlet pipe 75 connects the water-cooled condenser outlet pipe 72 and the chiller-side expansion valve 79. The chiller-side expansion valve outlet pipe 76 connects the chiller-side expansion valve 79 and an inlet of the inner channel of the chiller 18 through which the refrigerant gas flows. The chiller outlet pipe 77 connects an outlet of the inner channel of the chiller 18 through which the refrigerant gas flows and a refrigerant gas suction port of the compressor 57.

As illustrated in FIG. 2, the grille shutter (GS) 80 opens and closes a front grille 203 disposed in a front part of a front compartment 202 of a vehicle 200. The front compartment 202 is a space disposed at a front of the vehicle 200 and houses the motor device 11, the PCU 12, the air-conditioning unit 50, the driving system radiator (DSR) 14, and the air-conditioning system radiator (ASR) 53. The grille shutter (GS) 80 in an open state allows the outside air to flow through the front grille 203 into the air-conditioning system radiator (ASR) 53 and the driving system radiator (DSR) 14 disposed within the front compartment 202, to thereby cool the refrigerant flowing through the cooling channel 30 and the heating medium flowing through the heater circuit 60. The grille shutter (GS) 80 in a closed state does not allow the outside air to flow into the front compartment 202.

Further, as illustrated in FIG. 2, the battery 13 is disposed under the floor panel 204 of the vehicle 200. The vehicle cabin 201 and the front compartment 202 are separated by a dash panel 205. The air-conditioning unit 50 disposed within the front compartment 202 includes a duct extending toward the vehicle cabin 201 to supply conditioned air to the vehicle cabin 201.

By reference back to FIG. 1, the controller 90 is a computer including a CPU 91 or a processor that performs information processing, and a memory 92 that stores control programs and data. Operation of the controller 90 is implemented by the CPU 91 executing the control program stored in the memory 92. The motor device 11, the PCU 12, the drive unit-side water pump 16, the three-way valve 21, the five-way valve 22, the battery heater 15, the battery-side water pump 17, the warming heater 51, the three-way control valve 56, the compressor 57, the evaporator-side expansion valve 78, the chiller-side expansion valve 79, and the grille shutter (GS) 80 each operate in accordance with instructions from the controller 90.

Temperature data detected by the motor temperature sensor 23, the PCU temperature sensor 24, the battery water temperature sensor 25, and the heater core inlet water temperature sensor 26 are input to the controller 90.

The connection modes of the five-way valve 22 will be now described by reference to FIG. 3. The five-way valve 22 operates in three connection modes: a channel separation mode shown in an upper left portion of FIG. 3; a serial connection mode shown in an upper right portion of FIG. 3, and a battery bypass serial connection mode shown at the bottom of FIG. 3.

In the channel separation mode in the upper left drawing, the cooling channel 30 is separated into a drive unit return channel 30A to allow the refrigerant to flow back to the drive unit 10, and a battery return channel 30B to allow the refrigerant to flow back to the battery 13.

As illustrated in the upper left drawing in FIG. 3, in the channel separation mode, the first port 22a and the fourth port 22d are connected, the second port 22b and the third port 22c are connected, and the fifth port 22e is closed. Further, the first port 22a and the second port 22b are disconnected, and the third port 22c and the fourth port 22d are disconnected. This allows the refrigerant discharged from the drive-unit-side water pump 16 to flow sequentially through the drive unit 10, the first port 22a, the fourth port 22d, the driving system radiator (DSR) 14, the three-way valve 21, and the drive-unit-side water pump 16, as indicated with bold arrows in the drawing. This flow channel constitutes the drive unit return channel 30A that allows the refrigerant to flow back to the drive unit 10. Meanwhile, the refrigerant discharged from the battery-side water pump 17 flows sequentially through the third port 22c, the second port 22b, the battery 13, and the battery-side water pump 17. This flow channel constitutes the battery return channel 30B that allows the refrigerant to flow back to the battery 13. As described above, the channel separation mode separates the cooling channel 30 into the drive unit return channel 30A and the battery return channel 30B.

In the serial connection mode illustrated in the upper right drawing in FIG. 3, the drive unit 10 and the battery 13 are connected in series to allow the refrigerant to flow serially through the drive unit 10 and the battery 13.

As illustrated in the upper right drawing in FIG. 3, in the serial connection mode, the first port 22a and the second port 22b are connected, the third port 22c and the fourth port 22d are connected, and the fifth port 22e is closed. Further, the first port 22a and the fourth port 22d, which are connected in the channel separation mode, and the second port 22b and the third port 22c, which are also connected in the channel separation mode, are disconnected. This allows the refrigerant discharged from the drive-unit-side water pump 16 to flow sequentially through the drive unit 10, the first port 22a, the second port 22b, the battery 13, the battery-side water pump 17, the third port 22c, the fourth port 22d, the driving system radiator (DSR) 14, the three-way valve 21, and the drive-unit-side water pump 16, as indicated with bold arrows in the drawing. This flow channel constitutes the cooling channel 30 in which the drive unit 10 and the battery 13 are connected in series such that the battery 13 is located downstream of the drive unit 10 to allow the refrigerant to flow serially through the drive unit 10 and the battery 13. As such, in the serial connection mode, the drive unit return channel 30A and the battery return channel 30B are connected in series.

In the battery bypass serial connection mode illustrated in the bottom drawing in FIG. 3, the drive unit 10 and the battery bypass channel 46 are connected in series to allow the refrigerant to flow through the drive unit 10 while bypassing the battery 13.

As illustrated in the bottom drawing in FIG. 3, in the battery bypass serial connection mode, the first port 22a and the fifth port 22e are connected, the second port 22b is closed, and the third port 22c and the fourth port 22d are connected. Further, similar to the serial connection mode, the first port 22a and the fourth port 22d are disconnected, and the second port 22b and the third port 22c are disconnected. This allows the refrigerant discharged from the drive-unit-side water pump 16 to flow sequentially through the drive unit 10, the first port 22a, the fifth port 22e, the battery bypass channel 46, the battery-side water pump 17, the third port 22c, the fourth port 22d, the driving system radiator (DSR) 14, the three-way valve 21, and the drive-unit-side water pump 16, as indicated with bold arrows in the drawing. This flow channel includes the drive unit 10 and the battery bypass channel 46 connected in series, to allow the refrigerant to flow through the drive unit 10 while bypassing the battery 13.

To switch the connection mode between the channel separation mode and the serial connection mode as indicated with a blank arrow 95 in FIG. 3, the five-way valve 22 functions as the third switching valve. To switch the connection mode between the serial connection mode and the battery bypass serial connection mode as indicated with a blank arrow 96 in FIG. 3, the five-way valve 22 functions as the second switching valve.

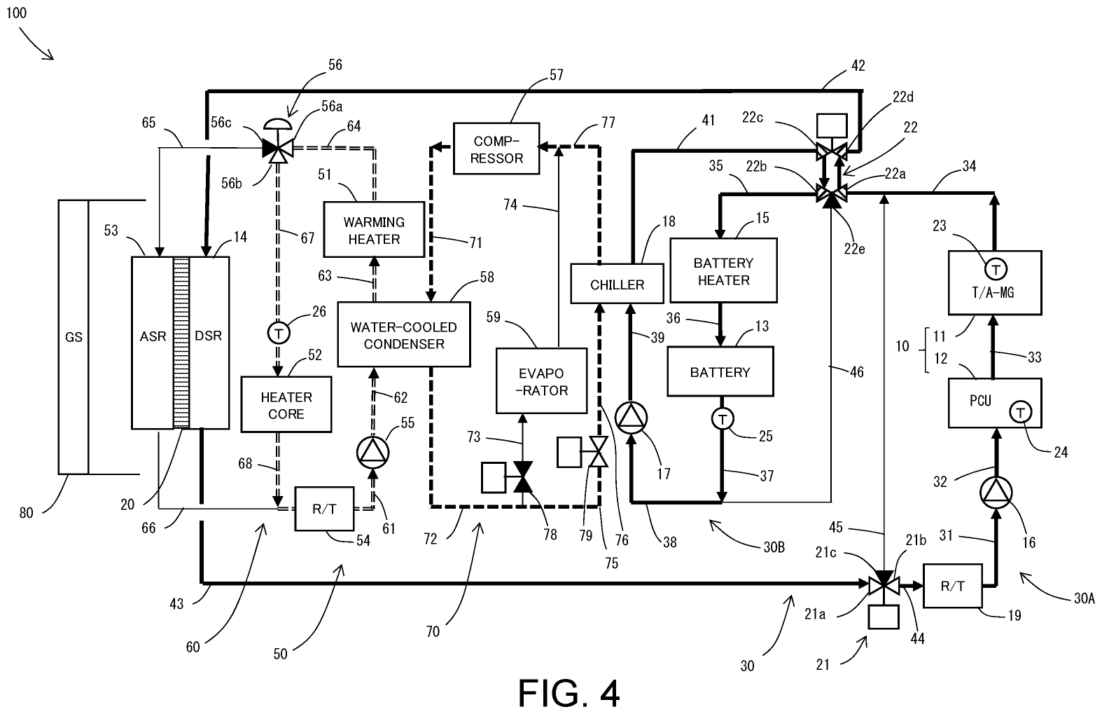

The operation of the vehicle cooler 100 in the vehicle 200 traveling in a low-temperature environment while heating the vehicle cabin 201 will be described by reference to FIG. 4. As illustrated in FIG. 4, the controller 90 switches the five-way valve 22 into the channel separation mode. The controller 90 further switches the three-way valve 21 toward the drive unit side to allow the first port 21a and the second port 21b to communicate. The controller 90 further switches the three-way control valve 56 into the radiator block mode to block the flow of the heating medium through the air-conditioning system radiator (ASR) 53. In this case, all the heating medium discharged from the heater-side water pump 55 flows through the heater core 52. The controller 90 also operates the compressor 57, closes the evaporator-side expansion valve 78, and opens the chiller-side expansion valve 79. The controller 90 further opens the grille shutter (GS) 80.

This constitutes the drive unit return channel 30A in which a refrigerant flows sequentially through the drive-unit-side water pump 16, the PCU 12, the motor device 11, the first port 22a of the five-way valve 22, the fourth port 22d of the five-way valve 22, the driving system radiator (DSR) 14, the three-way valve 21, and the reservoir tank 19, as indicated with bold arrows in FIG. 4. The battery return channel 30B in which a refrigerant sequentially flows through the battery-side water pump 17, the chiller 18, the third port 22c, the second port 22b, the battery heater 15, the battery 13, and back to the battery-side water pump 17 is further constituted. As indicated with arrows with double broken line in FIG. 4, the heating medium of the heater circuit 60 flows through the heater-side water pump 55, the water-cooled condenser 58, the warming heater 51, the three-way control valve 56, the heater core 52, and the reservoir tank 54. Further, as indicated with bold arrows with broken line in FIG. 4, the refrigerant gas of the heat pump circuit 70 flows through the compressor 57, the water-cooled condenser 58, the chiller-side expansion valve 79, and the chiller 18.

The refrigerant in the drive unit return channel 30A is compressed by the drive-unit-side water pump 16 and flows through the PCU 12 and the motor device 11 to cool the PCU 12 and the motor device 11. The refrigerant having a raised temperature after flowing through the PCU 12 and the motor device 11 passes through the first port 22a and the fourth port 22d of the five-way valve 22, and flows into the driving system radiator (DSR) 14. With the grille shutter (GS) 80 being open, the refrigerant is cooled by the outside air flowing through the driving system radiator (DSR) 14, to thereby have a lowered temperature. The refrigerant having a lowered temperature passes through the three-way valve 21 and the reservoir tank 19 and returns to the drive-unit-side water pump 16. As such, the drive unit return channel 30A allows circulation of the refrigerant to cool the motor device 11 and the PCU 12.

The heating medium in the heater circuit 60 is heated by the warming heater 51. The heating medium heated and having a raised temperature flows into the heater core 52 where heat exchange between the heating medium and the air in the vehicle cabin 201 is performed. The heating medium thus raises the temperature of the air in the vehicle cabin 201. The heating medium having a lowered temperature due to heat exchange passes through the water-cooled condenser 58 and flows back to the warming heater 51. The compressor 57 in the heat pump circuit 70 compresses the refrigerant gas. The refrigerant gas thus compressed and having a raised temperature flows into the water-cooled condenser 58 where the refrigerant gas is subjected to heat exchange with the low-temperature heating medium flowing through the heater circuit 60 to heat the heating medium flowing through the heater circuit 60. The refrigerant gas having a lowered temperature due to the heat exchange in the water-cooled condenser 58 passes through the chiller-side expansion valve 79 and flows into the chiller 18 where the refrigerant gas is subjected to heat exchange with the refrigerant flowing through the battery return channel 30B and flows back to the compressor 57. With the heat exchange in the chiller 18, heat transfers from one of the refrigerant and the refrigerant gas having a higher temperature to the other of the refrigerant and the refrigerant gas having a lower temperature. The refrigerant in the battery return channel 30B is heated or cooled with the heat exchange in the chiller 18, and flows into the battery heater 15 through the third port 22c and the second port 22b of the five-way valve 22. When the outside air temperature is low, the refrigerant is heated by the battery heater 15 and then flows into the battery 13. The battery 13 is maintained at a temperature that is necessary for traveling of the vehicle 200, by the amount of heat for heating the refrigerant of the battery heater 15 and the amount of exchanged heat in the chiller 18.

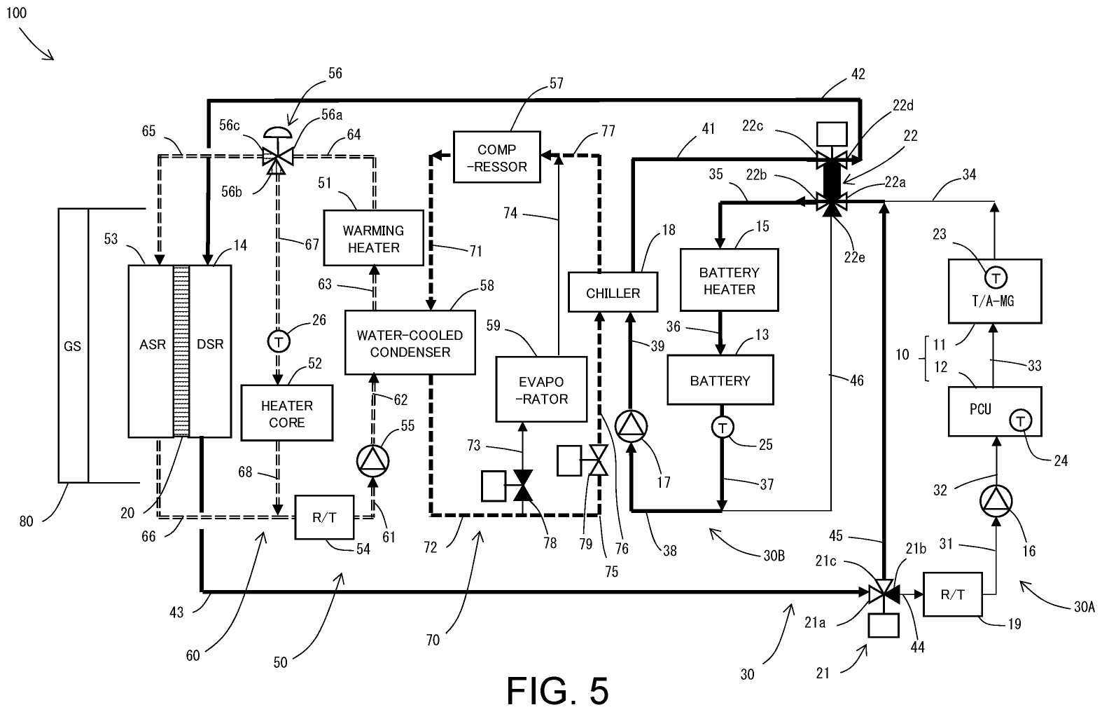

The operation of the vehicle cooler 100 in an initial stage where the vehicle 200 is activated to start traveling in a low-temperature environment will now be described by reference to FIG. 5 to FIG. 9. In the low temperature environment, the battery 13 has a low temperature and low charge and discharge efficiency. It is therefore necessary to raise the temperature of the battery 13 to increase the charge and discharge efficiency of the battery 13. To this end, the vehicle cooler 100 includes the battery heater 15, which raises the temperature of the refrigerant flowing through the battery 13. However, a temperature rise of the battery 13 with the battery heater 15 lowers power performance of the vehicle 200. The power performance as used herein refers to a traveling distance of the vehicle 200 per unit power. The vehicle cooler 100 according to the present embodiment uses the heat generated by self-heating of the drive unit 10, for a temperature rise of the battery 13, thereby increasing the power performance of the vehicle 200 in low-temperature environments.

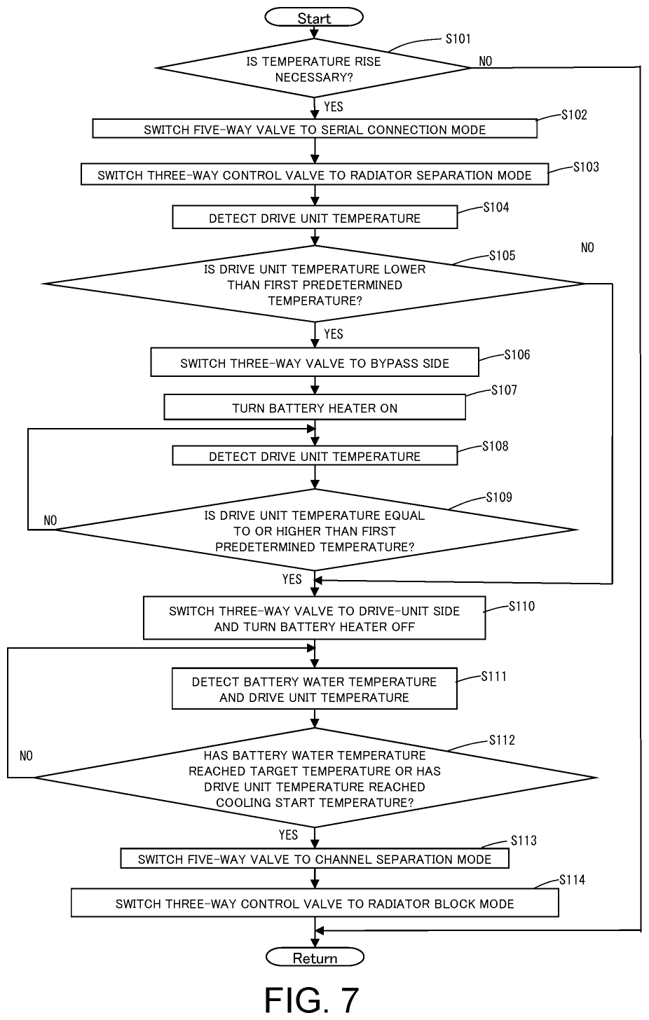

In step S101 in FIG. 7, the controller 90 determines whether a temperature rise of the battery 13 is necessary. Whether a temperature rise is necessary may be determined based on whether the battery 13 has a low temperature and therefore has a lowered charge and discharge efficiency, or whether the battery 13 having a low temperature needs an output limit. In response to the controller 90 determining YES in step S101 in FIG. 7, the process proceeds to step S102. Meanwhile, in response to determination NO in step S101, the controller 90 continues traveling of the vehicle 200 without performing a temperature rise processing of the battery 13.

In step S102 in FIG. 7, the controller 90 switches the five-way valve 22 to the serial connection mode. In step S103, the controller 90 switches the three-way control valve 56 to the radiator separation mode. As described above, the radiator separation mode is a control mode that allows the heating medium flowing from the first port 56a to pass through the second port 56b and the third port 56c at a predetermined ratio. This control causes part of the heating medium heated with the warming heater 51 to pass through the second port 56b and the heater core 52 and further flow into the reservoir tank 54. The remaining part of the heating medium passes through the third port 56c and the air-conditioning system radiator (ASR) 53 and flows into the reservoir tank 54.

After switching the control modes of the five-way valve 22 and the three-way control valve 56, the controller 90 proceeds to step S104 where the motor temperature sensor 23 and the PCU temperature sensor 24 detect temperatures of the motor device 11 and the PCU 12, respectively. The temperature of the motor device 11 and the temperature of the PCU 12 constitute the temperature of the drive unit 10.

Then, in step S105, the controller 90 determines whether the temperature of the motor device 11 and the temperature of the PCU 12 are lower than a first predetermined temperature. Here, the first predetermined temperature is a temperature at which the motor device 11 or the PCU 12 is able to generate heat for a temperature rise of the battery 13 and which is higher than a target temperature of the battery water temperature. In a low temperature environment, for example, oil within the motor device 11 is solidified to prevent effective transfer of the heat generated by self-heating of the motor device 11 to the refrigerant. Effective transfer of the heat generated by self-heating of the motor device 11 is achieved by liquidifying the oil with heat generated by self-heating of the motor device 11 to allow the liquid oil to circulate within the motor device 11. The first predetermined temperature may therefore be a temperature at which circulation of the oil within the motor device 11 is possible and which is higher than the target temperature of the battery water temperature. The first predetermined temperature may be set to individual values for the motor device 11 and the PCU 12, respectively, or may be set to a common value.

When the temperatures of the motor device 11 and the PCU 12 are lower than the first predetermined temperature, allowing the refrigerant to flow through the motor device 11 and the PCU 12 would lower the temperature of the refrigerant, and allowing such a refrigerant to flow through battery 13 would not achieve the temperature rise of the battery 13 in a short time. Therefore, in response to the controller 90 determining YES in step S105 in FIG. 7, the process proceeds to step S106 where the three-way valve 21 is switched toward bypass. Here, switching toward bypass refers to switching the three-way valve 21 to connect the first port 21a and the third port 21c to allow the refrigerant flowing in through the first port 21a to flow through the third port 21c to the drive unit bypass channel 45. At this time, the second port 21b is closed. The process then proceeds to step S107, in which the controller 90 turns the battery heater 15 ON.

Switching the five-way valve 22 to the serial connection mode and switching the three-way valve 21 to bypass as described above enables the refrigerant in the cooling channel 30 to flow through the battery-side water pump 17, the chiller 18, the five-way valve 22, the driving system radiator (DSR) 14, and the three-way valve 21, and thereafter flows through the drive unit bypass channel 45 and into the motor device outlet pipe 34, as indicated with bold arrows in FIG. 5. Thereafter, the refrigerant flows from the motor device outlet pipe 34 to the five-way valve 22, the battery heater 15, and the battery 13. The battery heater 15 that is now turned ON heats the refrigerant in the cooling channel 30. The refrigerant having a raised temperature flows through the inner channel of the battery 13 to raise the temperature of the battery 13.

Further, the vehicle 200 is activated in low temperature environment and heating is active; therefore, the controller 90 turns the warming heater 51 ON. In activation in low temperature environment, the controller 90 closes the grille shutter (GS) 80; therefore, the outside air is not introduced into the air-conditioning system radiator (ASR) 53 and the driving system radiator (DSR) 14.

In response to the controller 90 switching the three-way control valve 56 to the radiator separation mode, part of the heating medium heated by the warming heater 51 flows through the heater core 52 to heat the air in the vehicle cabin 201, and another part of the heating medium flows through the air-conditioning system radiator (ASR) 53, as indicated with arrows with double broken lines in FIG. 5. The air-conditioning system radiator (ASR) 53 and the driving system radiator (DSR) 14 are connected via the heat conductive member 20. With no outside air being introduced into the air-conditioning system radiator (ASR) 53 and the driving system radiator (DSR) 14, the heated heating medium flowing through the inner channel of air-conditioning system radiator (ASR) 53 is subjected to heat exchange, via the heat conductive member 20, with the refrigerant flowing through the inner channel of the driving system radiator (DSR) 14 to heat the refrigerant. The refrigerant in the cooling channel 30 thus heated flows through the inner channel of the battery 13 through the three-way valve 21 and the five-way valve 22 to effectively heat the battery 13. The refrigerant having a lowered temperature by flowing through the inner channel of the battery 13 is boosted by the battery-side water pump 17, and returns from the five-way valve 22 back to the driving system radiator (DSR) 14. As described above, the temperature of the battery 13 is raised with the use of the heat of the warming heater 51 that heats the vehicle cabin 201.

The controller 90 further operates the compressor 57, closes the evaporator-side expansion valve 78, and opens the chiller-side expansion valve 79. This allows the refrigerant gas in the heat pump circuit 70 to flow through the compressor 57, the water-cooled condenser 58, the chiller-side expansion valve 79, and the chiller 18, as indicated with bold broken arrows in FIG. 5. The refrigerant gas compressed by the compressor 57 and having a raised temperature is subjected to heat exchange in the water-cooled condenser 58 with the heating medium flowing through the heater circuit 60, to raise the temperature of the heating medium. Part of the temperature-raised heating medium flows through the inner channel of the driving system radiator (DSR) 14 via the air-conditioning system radiator (ASR) 53 and the heat conductive member 20 to thereby raise the temperature of the refrigerant. As such, the controller 90 drives the compressor 57 to thereby raise the temperature of the refrigerant in the cooling channel 30.

As described above, after activation of the vehicle 200, the valves are switched as described above to achieve the channel configuration as illustrated in FIG. 5, and also the battery heater 15 and the warming heater 51 are turned ON and the compressor 57 is operated. This enables heating of the refrigerant in the cooling channel 30 with the amount of heat from the battery heater 15, the amount of heat from the warming heater 51, and the amount of heat from the compressor 57, and then enables the temperature rise of the battery 13 with the heated refrigerant. At this time, the three-way valve 21 is switched toward bypass, which prevents the refrigerant from flowing through the drive unit 10. This allows the amount of heat from the warming heater 51 and the amount of heat from the compressor 57 to be used only for the temperature rise of the battery 13, and this leads to the temperature rise of the battery 13 in a short time.

In step S108 in FIG. 7, the controller 90 detects the temperature of the drive unit 10, and then in step S109, the controller 90 determines whether the temperature of the drive unit 10 is the first predetermined temperature or higher. In response to determination NO in step S109, the controller 90 continues the operation, with the battery heater 15 being active in the channel configuration illustrated in FIG. 5, to thereby raise the temperature of the battery 13.

The vehicle 200 is traveling, and therefore the motor device 11 and the PCU 12 are generating heat due to heat transfer resistance, for example. The motor device 11 and the PCU 12, upon reaching the first predetermined temperature or higher, enable heating of the refrigerant with heat generated by the motor device 11 and the PCU 12. In response to the controller 90 determining YES in step S109 in FIG. 7, the process proceeds to step S110 where the controller 90 switches the three-way valve 21 toward the drive unit side and also turns the battery heater 15 OFF. Here, switching the three-way valve 21 toward the drive unit side refers to switching the three-way valve 21 to connect the first port 21a and the second port 21b to allow the refrigerant flowing in through the first port 21a to flow from the second port 21b into the drive unit 10. At this time, the third port 21c is closed.

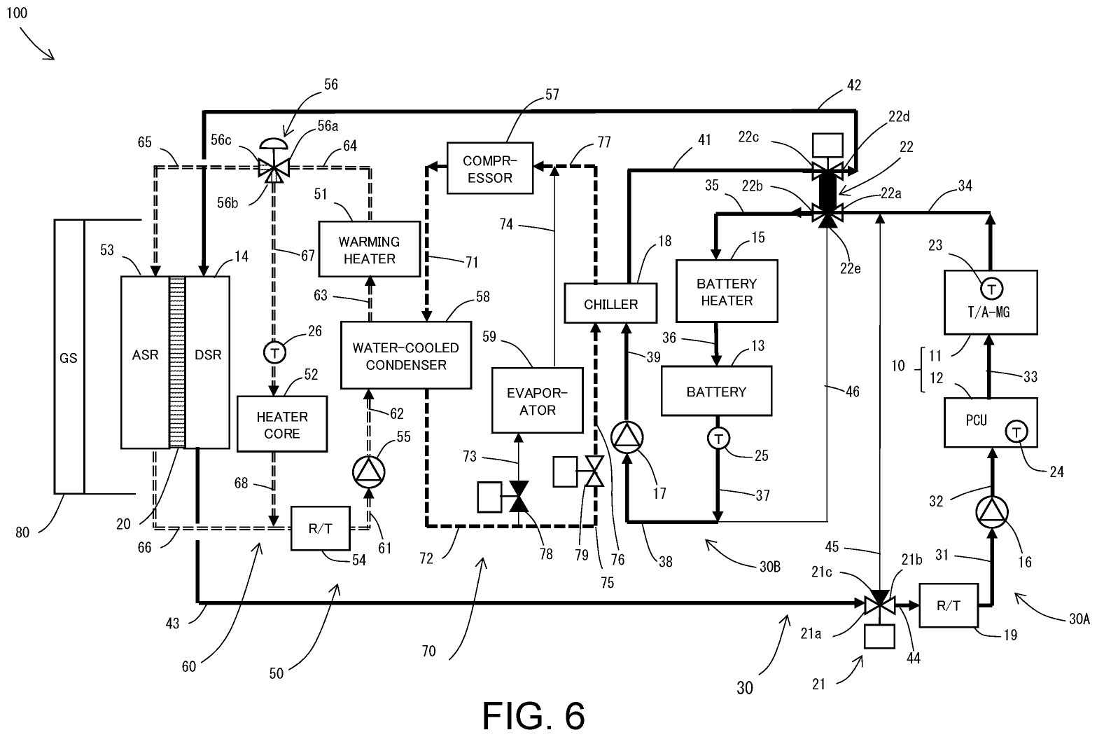

As described above, switching the three-way valve 21 toward the drive unit side allows the refrigerant in the cooling channel 30 to flow through the drive-unit-side water pump 16, the PCU 12, the motor device 11, the five-way valve 22, the battery heater 15, the battery 13, the battery-side water pump 17, the chiller 18, the five-way valve 22, the driving system radiator (DSR) 14, the three-way valve 21, and the reservoir tank 19, as indicated with the bold arrows in FIG. 6. The low-temperature refrigerant flowing out from the battery 13 is compressed by the battery-side water pump 17 and flows into the inner channel of the driving system radiator (DSR) 14. The refrigerant flowing through the inner channel of the driving system radiator (DSR) 14 is heated by the amount of heat from the warming heater 51 and the amount of heat from the compressor 57. The heated refrigerant is compressed by the drive-unit-side water pump 16, and flows into the PCU 12 and the motor device 11. At this time, the temperature of the drive unit 10 is equal to or higher than the first predetermined temperature; therefore, the refrigerant flowing through the inner channel of the PCU 12 and the inner channel of the motor device 11 is further heated by the PCU 12 and the motor device 11 and flows into the battery 13. The heated refrigerant thus flows back to the battery 13 to raise the temperature of the battery 13.

As described above, in the vehicle cooler 100, when the temperature of the drive unit 10 is equal to or higher than the first predetermined temperature, the temperature of the battery 13 is raised by the amount of generated heat from the motor device 11 and the PCU 12, in addition to the amount of heat from the warming heater 51 and the amount of heat from the compressor 57.

In response to the controller 90 determining NO in step S105 in FIG. 7, the process proceeds to step S110 and the controller 90 switches the three-way valve 21 toward the drive unit side and also turns the battery heater 15 OFF. The controller 90 then raises the temperature of the battery 13 by the amount of heat from the warming heater 51, the amount of heat from the compressor 57, and the heat generated by the drive unit 10.

In step S111, the controller 90 detects the battery water temperature with the battery water temperature sensor 25, and detects the temperature of the motor device 11 and the temperature of the PCU 12 with the motor temperature sensor 23 and the PCU temperature sensor 24, respectively. The temperature of the motor device 11 and the temperature of the PCU 12 refer to the temperature of the drive unit 10. In step S112, the controller 90 determines whether the battery water temperature has reached the target temperature or the temperature of the drive unit 10 has reached the cooling start temperature. In response to determination NO in step S112, the process returns to step S111 where the controller 90 continues the temperature rise of the battery 13.

When the battery water temperature reaches the target temperature, no further temperature rise of the battery 13 is required. Meanwhile, when the temperature of the drive unit 10 reaches the cooling start temperature, it is necessary to place a higher priority to cooling of the drive unit 10 than to a temperature rise of the battery 13.

Therefore, in response to determination YES in step S112, the process proceeds to step S113 where the controller 90 switches the five-way valve 22 to the channel separation mode. The process then proceeds to step S114 where the controller 90 switches the three-way control valve 56 to the radiator block mode. As described above, in the radiator block mode, the heating medium flowing to the air-conditioning system radiator (ASR) 53 is blocked by setting the ratio of the flow-out rate of the heating medium from the second port 56b of the three-way control valve 56 and the flow-out rate of the heating medium from the third port 56c of the three-way control valve 56 to 100:0.

Switching the five-way valve 22 and the three-way control valve 56 in this manner separates the cooling channel 30 into the drive unit return channel 30A and the battery return channel 30B as described above by reference to FIG. 4. The refrigerant discharged from the drive-unit-side water pump 16 circulates through the PCU 12, the motor device 11, and the driving system radiator (DSR) 14. The controller 90 opens the grille shutter (GS) 80. This allows the refrigerant flowing through the motor device 11 and the PCU 12 and having a raised temperature to be cooled by the driving system radiator (DSR) 14 and return to the motor device 11 and the PCU 12 to thereby cool the motor device 11 and the PCU 12. The vehicle 200 then continues traveling with the flow channel configuration as described above by reference to FIG. 4.

Further, the refrigerant discharged from the battery-side water pump 17 circulates through the battery heater 15, the battery 13, and the chiller 18. In response to the battery water temperature having not reached the target temperature, the controller 90 turns the battery heater 15 ON and continues to boost the battery 13. In response to the temperature of the battery 13 having reached the target temperature, the controller 90 keeps the battery heater 15 OFF.

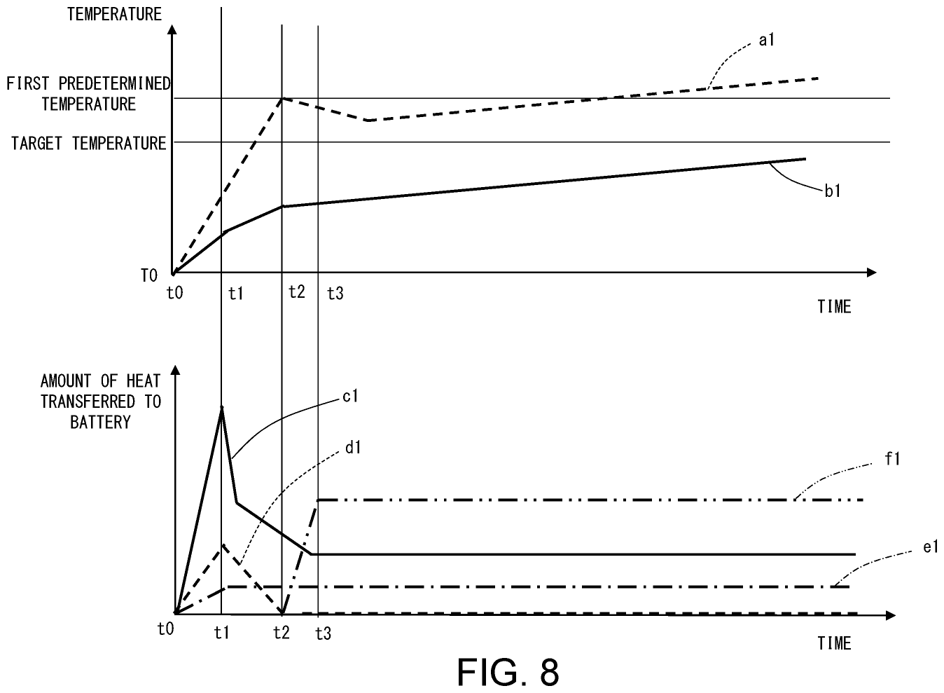

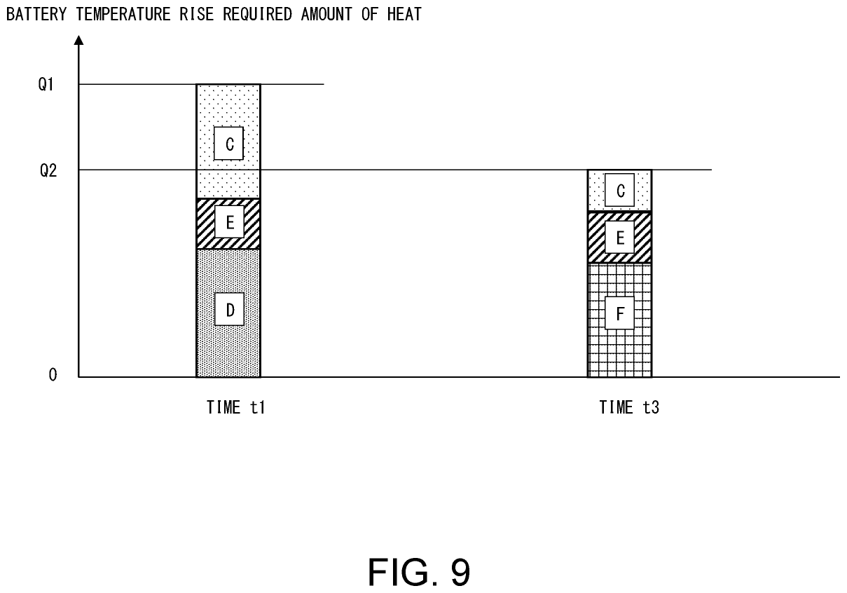

By reference to FIGS. 8 and 9, there will be described a change, with time, of the amount of heat transferred to the battery 13 from each of the battery heater 15, the warming heater 51, and the compressor 57, and changes with time of the battery water temperature and the temperature of the drive unit 10, when the vehicle cooler 100 operates as described above.

In the graph at the top in FIG. 8, a broken line a1 indicates a change of the temperature of the drive unit 10 with time, as detected by the motor temperature sensor 23 and the PCU temperature sensor 24. A solid line b1 indicates a change of the battery water temperature with time, as detected by the battery water temperature sensor 25. In the graph at the bottom in FIG. 8, a solid line c1 indicates a change of the amount of heat transferred from the warming heater 51 via the heating medium and the refrigerant to the battery 13. A broken line d1 indicates a change of the amount of heat transferred from the battery heater 15, via the refrigerant, to the battery 13. An alternate long and short dashed line e1 indicates a change of the amount of heat transferred from the compressor 57, via the refrigerant gas, the heating medium, and the refrigerant, to the battery 13. A chain double-dashed line f1 indicates the amount of heat transferred from the drive unit 10 including the motor device 11 and the PCU 12, via the refrigerant, to the battery 13. In FIG. 8, a time t0 indicates a time point at which the vehicle 200 is activated, and a time t2 indicates a time point at which the temperature of the drive unit 10 reaches the first predetermined temperature.

As indicated by the solid line c1 in the graph at the bottom in FIG. 8, the amount of heat transferred from the warming heater 51 to the battery 13 gradually increases from the time t0 at which the vehicle 200 starts and the warming heater 51 is turned ON. Then, after the time t1 at which the temperature of the battery 13 has raised to some extent, the amount of heat transferred from the warming heater 51 to the battery 13 gradually decreases. This is because the controller 90 increases the output of the warming heater 51 to rapidly raise the battery water temperature at the beginning of activation, and, once the battery water temperature starts rising, the controller 90 then reduces the output of the warming heater 51 to such an extent that a rising rate of the battery water temperature is maintained. After the time t3 at which the amount of heat transferred from the drive unit 10 is constant as indicated by the chain double-dashed line f1, the amount of heat transferred from the warming heater 51 to the battery 13 is also substantially constant. This causes the battery water temperature to rise at a fixed rate as indicated with the solid line b1 shown at the top in FIG. 8.

As indicated by the broken line d1 in the graph at the bottom in FIG. 8, the amount of heat transferred from the battery heater 15 to the battery 13 gradually increases from the time t0 at which the vehicle 200 is activated and the battery heater 15 is turned ON. Then, after the time t1 at which the temperature of the battery 13 has raised to some extent, the amount of heat transferred from the battery heater 15 to the battery 13 gradually decreases. This is because the controller 90 increases the output of the battery heater 15 to rapidly raise the battery water temperature at the beginning of activation, and, once the battery water temperature starts rising, the controller 90 reduces the output of the battery heater 15 to such an extent that a rising rate of the battery water temperature is maintained. Then, when the battery heater 15 is turned OFF at the time t2 at which the temperature of the drive unit 10 reaches the first predetermined temperature, the amount of heat transferred from the battery heater 15 to the battery 13 decreases to zero.

As indicated by the alternate long and short dashed line e1 in the graph at the bottom in FIG. 8, the amount of heat transferred from the compressor 57 to the battery 13 gradually increases from the time t0 at which the vehicle 200 is activated and the battery heater 15 is turned ON. Then, after the time t1 at which the temperature of the battery 13 has raised to some extent, the amount of heat transferred from the compressor 57 to the battery 13 is substantially constant.

As indicated by the chain double-dashed line f1 in the graph at the bottom in FIG. 8, between the time t0 and the time t2, no refrigerant flows in the drive unit 10, and therefore the amount of heat transferred from the drive unit 10 to the battery 13 is zero. At the time t2, the three-way valve 21 is switched toward the drive unit side to allow the refrigerant to start flowing through the drive unit 10, which gradually increases the amount of heat transferred from the drive unit 10 to the battery 13. After the time t3, the amount of heat transferred from the drive unit 10 to the battery 13 is constant.

As indicated by the broken line a1 in the graph at the top in FIG. 8, during the period between the time t0 and the time t2 in which the refrigerant does not flow in the drive unit 10, the temperature of the drive unit 10 continues to rise due to self-heating. At the time t2 at which the temperature of the drive unit 10 reaches the first predetermined temperature, the three-way valve 21 is switched toward the drive unit side to allow the refrigerant to start flowing through the drive unit 10. The temperature of the drive unit 10 temporarily lowers due to the refrigerant flowing into the drive unit 10, but thereafter rises again due to self-heating.

As indicated by the solid line b1 in the graph at the top in FIG. 8, the battery water temperature gradually rises from the time to.

The output of the warming heater 51, the output of the compressor 57, and the output of the battery heater 15 are regulated by the controller 90 as appropriate in accordance with the temperature rises of the battery 13 and the drive unit 10.

Now, a change of the ratio of the amount of heat D transferred from the battery heater 15, the amount of heat C transferred from the warming heater 51, the amount of heat E transferred from the compressor 57, and the amount of heat F transferred from the drive unit 10 will be described by reference to FIG. 9.

A bar graph on the left in FIG. 9 indicates the ratio of the amount of heat C, the amount of heat D, and the amount of heat E at the time t1. As indicated by the left bar graph, the amount of heat C transferred from the warming heater 51 is about 40% of the battery temperature-rise required amount of heat Q1, the amount of heat E transferred from the compressor 57 is about 20% of the battery temperature-rise required amount of heat Q1, and the amount of heat D transferred from the battery heater 15 is about 40% of the battery temperature-rise required amount of heat Q1. At the time t1, the three-way valve 21 is switched toward the bypass side, and therefore the amount of heat transferred from the drive unit 10 to the battery 13 is zero.

At the time t2, the battery heater 15 is turned OFF and the three-way valve 21 is switched toward the drive unit side. The temperature of the battery 13 rises to a certain extent; therefore, the battery temperature-rise required amount of heat Q2 at the time t3 is smaller than the battery temperature-rise required amount of heat Q1 at the time t1. At the time t3, the amount of heat C transferred from the warming heater 51 is about 20% of the battery temperature-rise required amount of heat Q2, the amount of heat E transferred from the compressor 57 is about 25% of the battery temperature-rise required amount of heat Q2, and the amount of heat F transferred from the drive unit 10 is about 55% of the battery temperature-rise required amount of heat Q2. As described, at the time t3, the amount of heat generated by the drive unit 10 which is to be externally discharged out of the driving system radiator (DSR) 14 can be utilized to provide 55% of the battery temperature-rise required amount of heat Q2. This increases the power efficiency of the vehicle 200.

As described above, in a low temperature environment, the vehicle cooler 100, between the time t0 and the time t2 after the vehicle 200 is activated, switches the three-way valve 21 toward the bypass side to prevent the refrigerant from flowing in the drive unit 10 to thereby reduce the heat capacity of devices through which the refrigerant flows. In this state, the vehicle cooler 100 raises the temperature of the battery 13 with the amount of heat from the battery heater 15, the amount of heat from the warming heater 51, and the amount of heat from the compressor 57. Meanwhile, in the period between the time t0 and the time t2, in which no refrigerant flows in the drive unit 10, the temperature of the drive unit 10 rises in a short time due to self-heating.

After the time t2 at which the temperature of the drive unit 10 rises to the first predetermined temperature, the vehicle cooler 100 switches the three-way valve 21 toward the drive unit side to heat the refrigerant with the amount of heat generated by the drive unit 10 and allows the heated refrigerant to flow through the battery 13. In this manner, after the time t2, the vehicle cooler 100 raises the temperature of the battery 13 with the amount of heat from the battery heater 15, the amount of heat from the warming heater 51, the amount of heat from the compressor 57, and the amount of heat generated by the drive unit 10. This enables rise of the battery water temperature to the target temperature in a short time at the time of activation of the vehicle 200. The temperature rise of the battery 13 in a short time further increases the charge and discharge efficiency of the battery 13 in a short time. The amount of heat generated by the drive unit 10, which is to be discharged out of the driving system radiator (DSR) 14, is used to raise the temperature of the battery 13, leading to an increase in the power efficiency of the vehicle 200.

In the above description, the controller 90 drives the compressor 57 after activation of the vehicle 200 to raise the temperature of the battery 13 with the amount of heat from the compressor 57. In another example, the controller 90 may raise the temperature of the battery 13 with the amount of heat from the warming heater 51 and the amount of heat from the battery heater 15, or with the amount of heat from the warming heater 51 and heat generated by the drive unit 10, without driving the compressor 57 after activation of the vehicle 200.

Further, while in the above example, the vehicle cooler 100 switches the cooling channel 30 by the five-way valve 22, the vehicle cooler 100 may be configured to achieve similar flow channel switching with a combination of a plurality of valves.

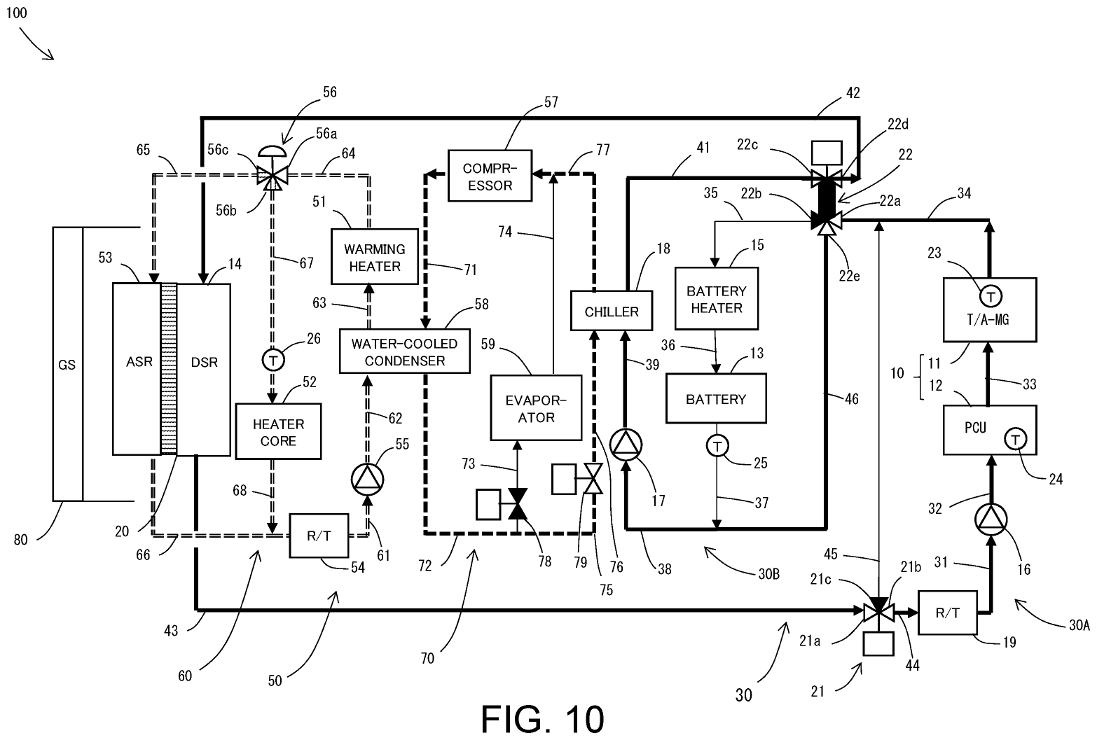

A further operation of the vehicle cooler 100 will be described by reference to FIG. 10 to FIG. 13. This operation refers to heating of the vehicle cabin 201 and a temperature rise of the battery 13 in a state where the vehicle 200 is stopped after being activated in a low temperature environment.

As illustrated in FIG. 10, with this operation, contrary to the operation described above by reference to FIG. 5 to FIG. 9, the three-way valve 21 is switched toward the drive unit side and the five-way valve 22 is switched to the battery bypass serial mode to thereby prevent the refrigerant from flowing in the battery 13 after activation of the vehicle 200. In this state, the temperature of the drive unit 10 is raised to the second predetermined temperature with the amount of heat from the warming heater 51, the amount of heat from the compressor 57, and the amount of heat by self-heating of the drive unit 10. After the temperature of the drive unit 10 rises to the second predetermined temperature, the five-way valve 22 is switched to the serial connection mode, as illustrated in FIG. 6, to enable temperature rise of the battery 13 with the amount of heat from the warming heater 51, the amount of heat from the compressor 57, the amount of heat from the battery heater 15, and the amount of heat from the drive unit 10. This operation will be described below.

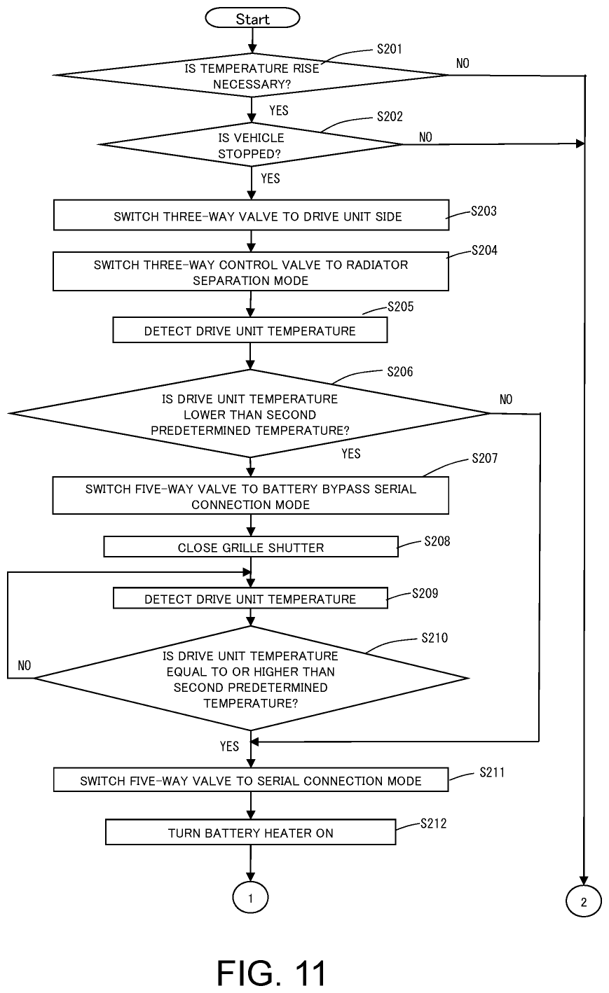

As indicated by step S201 in FIG. 11, the controller 90 determines whether the temperature rise of the battery 13 is necessary. In response to determination YES in step S201, the process proceeds to step S202 where the controller 90 determines whether the vehicle 200 is stopped. Whether the vehicle 200 is stopped may be determined based on the vehicle speed being a predetermined threshold or lower, the parking brake being active, and the gears to a parking position, for example. In response to the controller 90 determining YES in step S202, the process further proceeds to step S203 in FIG. 11.

In response to determining NO in step S201 or step S202, the controller 90 does not perform temperature rise operation of the battery 13 and terminates the operation.

In step S203 in FIG. 11, the controller 90 switches the three-way valve 21 toward the drive unit side. As described above, switching to the drive unit side refers to switching the three-way valve 21 to connect the first port 21a and the second port 21b to allow the refrigerant flowing in through the first port 21a to flow out through the second port 21b to the drive unit 10. At this time, the third port 21c is closed. The process then proceeds to step S204 in FIG. 11, where the controller 90 switches the three-way control valve 56 to the radiator separation mode.

The controller 90 detects the temperature of the drive unit 10 in step S205 in FIG. 11, and further determines whether the temperature of the drive unit 10 is lower than the second predetermined temperature in step S206. Here, the second predetermined temperature refers to a temperature at which an effective temperature rise of the battery 13 is possible with the amount of heat generated by the drive unit 10, and which is a temperature higher than the target temperature of the battery water temperature. The second predetermined temperature may be the same as or different from the first predetermined temperature described above.

In response to determination YES in step S206, the process proceeds to step S207 where the controller 90 switches the five-way valve 22 to the battery bypass serial connection mode. As described above by reference to FIG. 3, in the battery bypass serial connection mode, the drive unit 10 and the battery bypass channel 46 are connected in series to allow the refrigerant to flow through the drive unit 10 while bypassing the battery 13. In step S208, the controller 90 further closes the grille shutter (GS) 80.

Switching the three-way valve 21, the three-way control valve 56, and the five-way valve 22 in this manner allows the refrigerant in the cooling channel 30 to flow from the drive unit water pump 16 through the PCU 12, the motor device 11, and the five-way valve 22, and thereafter flow from the battery bypass channel 46 to the battery-side water pump inlet pipe 38, as indicated with bold arrows in FIG. 10. The refrigerant then flows from the battery-side water pump 17 to the chiller 18, the five-way valve 22, the driving system radiator (DSR) 14, the three-way valve 21, and the reservoir tank 19.

Here, the vehicle 200 is activated in a low temperature environment, and the heating is active; the controller 90 therefore has turned the warming heater 51 ON. The controller 90 closes the grille shutter (GS) 80, which prevents the introduction of the outside air into the air-conditioning system radiator (ASR) 53 and the driving system radiator (DSR) 14.

The operation of the heat pump circuit 70 is the same as the operation described above by reference to FIG. 5, and therefore will not be further described.

As described above, the operation to connect the cooling channel 30 and the battery bypass channel 46, turn the warming heater 51 ON, drive the compressor 57, and close the grille shutter (GS) 80 allows heating of the refrigerant in the cooling channel 30 with the amount of heat from the warming heater 51 and the amount of heat from the compressor 57 to raise the temperature of the drive unit 10 with the heated refrigerant, similar to the operation described above by reference to FIG. 5. At this time, no refrigerant flows in the battery 13, and the amount of heat from the warming heater 51 and the amount of heat from the compressor 57 are used only for the temperature rise of the drive unit 10. This enables the temperature rise of the drive unit 10 in a short time. The temperature of the drive unit 10 also rises due to self-heating.

As described above by reference to FIG. 2, the motor device 11 and the PCU 12 forming the drive unit 10, and the air-conditioning unit 50 are housed within the front compartment 202. Therefore, the temperature rise of the drive unit 10 causes a temperature rise in the atmosphere of the front compartment 202, which further accelerates the temperature rise of the drive unit 10.

The controller 90 detects the temperature of the drive unit 10 in step S209 in FIG. 11, and determines whether the temperature of the drive unit 10 rises to the second predetermined temperature or higher in step S210 in FIG. 11. In response to determination NO in step S210, the process returns to step S209 and the controller 90 continues the temperature rise of the drive unit 10.

In response to determination YES in step S210 in FIG. 11, the process proceeds to step S211 where the controller 90 switches the five-way valve 22 to the serial connection mode. The controller 90 then turns the battery heater 15 ON in step S212. This places the channel configuration of the vehicle cooler 100 in a state illustrated in FIG. 6. As described above by reference to FIG. 6, the temperature of the battery 13 is raised with the amount of heat of the battery heater 15, the amount of heat generated by the drive unit 10, the amount of heat of the warming heater 51, and the amount of heat of the compressor 57.

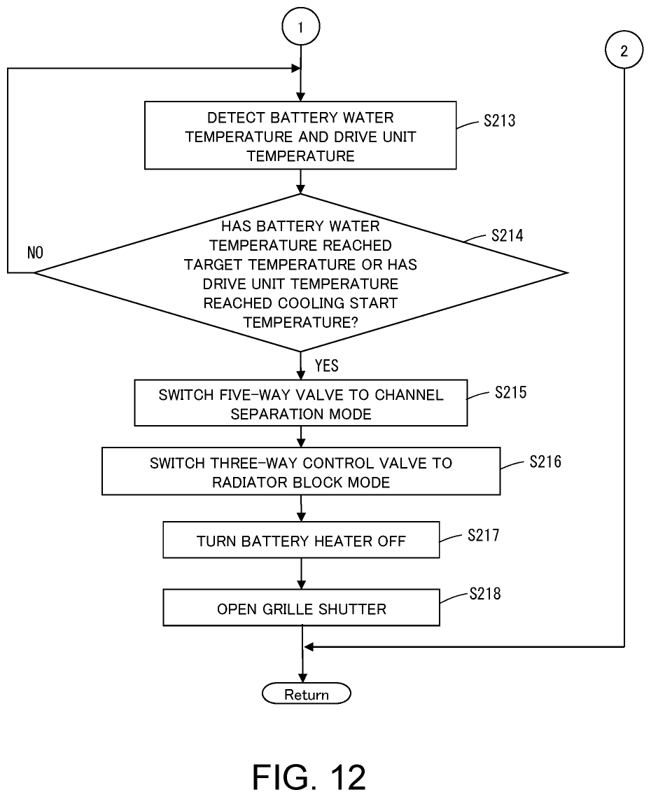

The controller 90 detects the battery water temperature and the temperature of the drive unit 10 in step S213 in FIG. 12, and determines whether the battery water temperature has reached the target temperature or the temperature of the drive unit 10 has reached the cooling start temperature in step S214 in FIG. 12. In response to determination YES in step S214, the controller 90 switches the five-way valve 22 to the channel separation mode in step S215. The controller 90 further switches the three-way control valve 56 to the radiator block mode in step S216. Then, the controller 90 turns the battery heater 15 OFF in step S217, and opens the grille shutter (GS) 80 in step S218.

The above operation separates the cooling channel 30 into the drive unit return channel 30A and the battery return channel 30B, as described above by reference to FIG. 4. The refrigerant discharged from the drive-unit-side water pump 16 circulates through the PCU 12, the motor device 11, and the driving system radiator (DSR) 14. The refrigerant flowing through the motor device 11 and the PCU 12 and having a raised temperature is cooled by the driving system radiator (DSR) 14 and returns to the motor device 11 and the PCU 12 to cool the motor device 11 and the PCU 12.

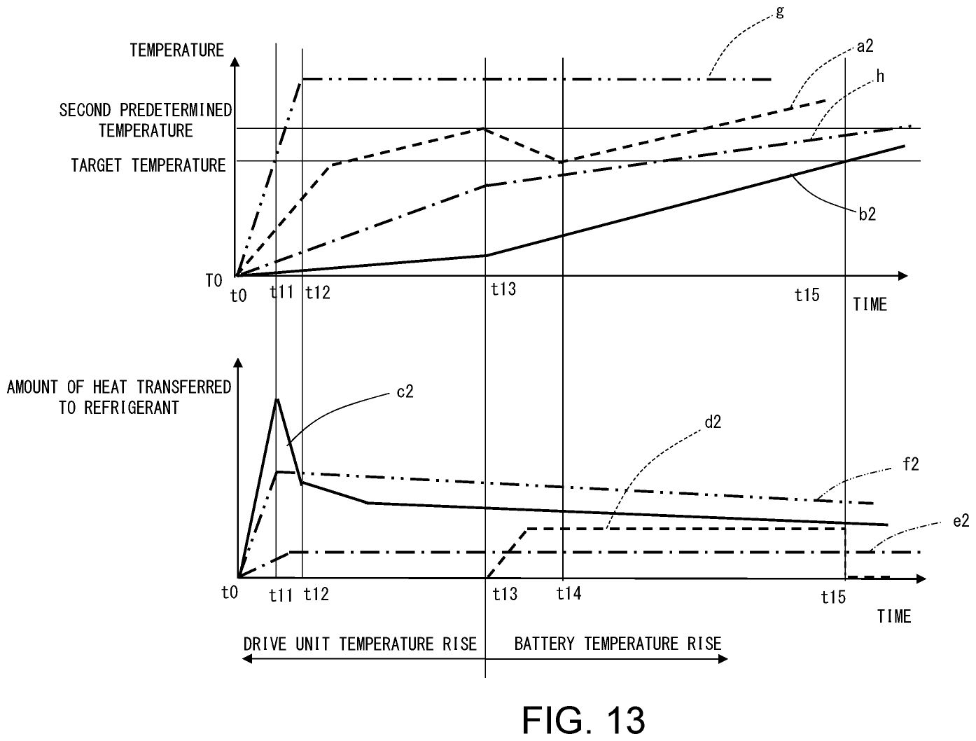

By reference to FIG. 13, there will be described a change, with time, of the amount of heat transferred to the refrigerant from each of the drive unit 10, the battery heater 15, the warming heater 51, and the compressor 57, and changes, with time, of the battery water temperature, the temperature of the drive unit 10, the atmosphere temperature in the front compartment 202, and the temperature of the heating medium in the heater circuit 60, when the vehicle cooler 100 operates as described above.

In the graph at the top in FIG. 13, a broken line a2 indicates the change, with time, of the temperature of the drive unit 10 detected by the motor temperature sensor 23 and the PCU temperature sensor 24. A solid line b2 indicates the change, with time, of the battery water temperature detected by the battery water temperature sensor 25. A chain double-dashed line g indicates the change, with time, of the temperature of the heating medium in the heater circuit 60 detected by the heater core inlet water temperature sensor 26. An alternate long and short dashed line h indicates the change, with time, of the temperature of the atmosphere in the front compartment 202.

In the graph at the bottom in FIG. 13, a solid line c2 indicates a change in the amount of heat transferred from the warming heater 51, via the heating medium, to the refrigerant. A broken line d2 indicates a change in the amount of heat transferred from the battery heater 15 to the refrigerant. An alternate long and short dashed line e2 indicates a change in the amount of heat transferred from the compressor 57, via the refrigerant gas and the heating medium, to the refrigerant. A chain double-dashed line f2 indicate a change in the amount of heat transferred from the drive unit 10 to the refrigerant.

In FIG. 13, a time t0 indicates a time at which the vehicle 200 is activated. A time t13 is a time at which the temperature of the drive unit 10 reaches the second predetermined temperature, the five-way valve 22 is switched from the battery bypass serial connection mode to the serial connection mode, and the battery heater 15 is turned ON. A time t15 is a time at which the battery water temperature reaches the target temperature, the five-way valve 22 is switched to the channel separation mode, and the three-way control valve 56 is switched to the radiator block mode.

Therefore, between the time t0 and the time t13, the amount of heat transferred from the warming heater 51 via the heating medium to the refrigerant, the amount of heat transferred from the compressor 57 via the refrigerant gas and the heating medium to the refrigerant, and the amount of heat transferred from the drive unit 10 to the refrigerant are used for the temperature rise of the drive unit 10 and the refrigerant. Between the time t13 and the time t15, the amount of heat transferred from the warming heater 51 via the heating medium to the refrigerant, the amount of heat transferred from the compressor 57 via the refrigerant gas and the heating medium to the refrigerant, the amount of heat transferred from the drive unit 10 to the refrigerant, and the amount of heat transferred from the battery heater 15 to the refrigerant are used for the temperature rise of the battery 13.

As indicated by the solid line c2 in the graph at the bottom of FIG. 13, the amount of heat transferred from the warming heater 51 to the refrigerant gradually increases from the time t0 at which the vehicle 200 is activated and the warming heater 51 is turned ON. Then, after the time t11 at which the temperature of the battery 13 has risen to a certain extent, the amount of heat transferred from the warming heater 51 to the refrigerant gradually lowers. After the time t12 at which the temperature of the heating medium in the heater circuit 60 indicated with the chain double-dashed line g in the graph at the top of FIG. 13 is at a fixed temperature, the amount of heat transferred from the warming heater 51 to the battery 13 is also substantially fixed. Between the time t0 and the time t13, the amount of heat transferred from the warming heater 51 to the refrigerant raises the temperatures of the drive unit 10 and the refrigerant. After the time t13, the amount of heat transferred from the warming heater 51 to the refrigerant raises the temperature of the battery 13.

As indicated by the broken line d2 in the graph at the bottom of FIG. 13, between the time t0 and the time t13, the battery heater 15 is turned OFF, and the amount of heat transferred from the battery heater 15 to the refrigerant is zero. During this period, the battery water temperature hardly rises. At the time t13, the five-way valve 22 is switched to the serial connection mode to start flowing of the refrigerant through the battery 13 and the battery heater 15 is turned ON. This allows start of an increase of the amount of heat transferred from the battery heater 15 to the refrigerant. After some time, the amount of heat transferred from the battery heater 15 to the refrigerant becomes constant. Then, after the time t15 at which the battery water temperature reaches the target temperature, the five-way valve 22 is switched to the channel separation mode, and the battery heater 15 is turned OFF, the amount of heat transferred from the battery heater 15 to the refrigerant is zero. The amount of heat transferred from the battery heater 15 to the refrigerant is used for the temperature rise of the battery 13.

As indicated by the alternate long and short dashed line e2 in the graph at the bottom of FIG. 13, the amount of heat transferred from the compressor 57 to the refrigerant gradually increases from the time t0 where the vehicle 200 is activated and the compressor 57 is turned ON. After the time t11 at which the temperature of the battery 13 has risen to a certain extent, the amount of heat transferred from the compressor 57 to the refrigerant becomes substantially constant. Similar to the amount of heat transferred from the warming heater 51 to the refrigerant, the amount of heat transferred from the compressor 57 to the refrigerant between the time t0 and the time t13 raises the temperatures of the drive unit 10 and the refrigerant. After the time t13, the amount of heat transferred from the compressor 57 to the refrigerant raises the temperature of the battery 13.

As indicated by the chain double-dashed line f2 in the graph at the bottom of FIG. 13, the amount of heat transferred from the drive unit 10 to the refrigerant increases between the time t0 and the t11, and thereafter gradually decreases, and then becomes substantially constant. The amount of heat transferred from the drive unit 10 to the refrigerant between the time t0 and the time t13 raises the temperature of the refrigerant. After the time t13, the amount of heat transferred from the drive unit 10 to the refrigerant raises the temperature of the battery 13.

As indicated by the broken line a2 in the graph at the top of FIG. 13, the temperature of the drive unit 10 continues to rise during the period between the time t0 and the time t13 at which the five-way valve 22 is switched to the battery bypass serial connection mode, and the amount of heat from the warming heater 51, and the amount of heat from the compressor 57, and self-heating of the drive unit 10 raise the temperature of the drive unit 10. At this time, the grille shutter (GS) 80 is closed, and therefore the atmosphere temperature of the front compartment 202 rises as indicated by the alternate long and short dashed line h in the graph at the top of FIG. 13. This immediately raises the temperature of the drive unit 10 stored in the front compartment 202.

At the time t13 at which the temperature of the drive unit 10 reaches the second predetermined temperature, the five-way valve 22 is switched to the serial connection mode, and the refrigerant flows through the battery 13 to start temperature rise of the battery 13. Then, the temperature of the refrigerant slightly lowers; therefore, the temperature of the drive unit 10 also slightly lowers. However, the amount of heat from the battery heater 15 raises the temperature of the drive unit 10, and after the time t14, the temperature of drive unit 10 rises.

The battery water temperature indicated with the solid line b2 in the graph at the top of FIG. 13 hardly rises during the period between the tine t0 and the time t13 at which no refrigerant flows in the battery 13. After the time t13 at which the five-way valve 22 is switched to the serial connection mode, the refrigerant flows through the battery 13, and the battery heater 15 is turned ON, the battery water temperature gradually rises and reaches the target temperature at the time t15.

The output of the warming heater 51, the output of the compressor 57, and the output of the battery heater 15 are regulated by the controller 90 as appropriate in accordance with the temperature rises of the battery 13 and the drive unit 10.

As described above, when the vehicle 200 is activated and is in a stopped state in a low temperature environment, the vehicle cooler 100 switches the three-way valve 21 toward the drive unit side and also switches the five-way valve 22 to the battery bypass serial connection mode, to thereby enable the temperature rise of the drive unit 10 in a short time with the amount of heat from the warming heater 51, the amount of heat from the compressor 57, and self-heating of the drive unit 10, while raising the atmosphere temperature of the front compartment 202 by closing the grille shutter (GS) 80. After raising the temperature of the drive unit 10 to the second predetermined temperature, the vehicle cooler 100 switches the five-way valve 22 to the serial connection mode to thereby enable the temperature rise of the battery 13 with the amount of heat from the warming heater 51, the amount of heat from the compressor 57, the amount of heat from the drive unit 10, and the amount of heat from the battery heater 15. This enables the vehicle cooler 100 to raise the battery water temperature to the target temperature in a short time, when the vehicle 200 is activated in a low temperature environment and is stopped. The vehicle cooler 100 further raises the temperature of the battery 13 in a short time to thereby enable an increase in the charge and discharge efficiency of the battery 13 in a short time.

As described above, the vehicle cooler 100 raises the temperature of the battery 13 with the amount of heat generated by the drive unit 10, which is to be discarded out of the driving system radiator (DSR) 14. This enables an increase of the power efficiency of the vehicle 200.

In the above example, the five-way valve 22 is switched to the battery bypass serial connection mode to cause the refrigerant to bypass the battery 13, thereby raising the temperature of the drive unit 10. However, the disclosure is not limited to this example. For example, between the time t0 and the time t13, the degree of opening of the second port 22b of the five-way valve 22 may be regulated to enable a small amount of refrigerant to flow through the battery heater 15 and the battery 13 to thereby raise the temperature of the battery 13 with the battery heater 15 being turned ON. Then, after the time t13, with the five-way valve 22 being switched to the serial connection mode and the battery heater 15 being turned OFF, the temperature of the battery 13 may be raised with the amount of heat from the warming heater 51, the amount of heat from the compressor 57, and the amount of heat from the drive unit 10.

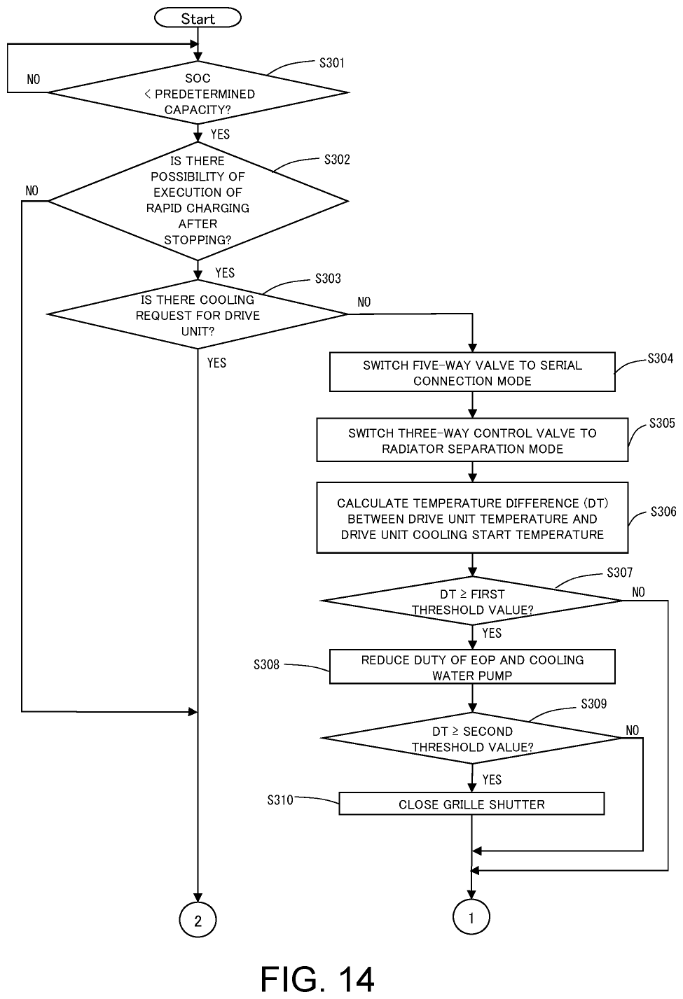

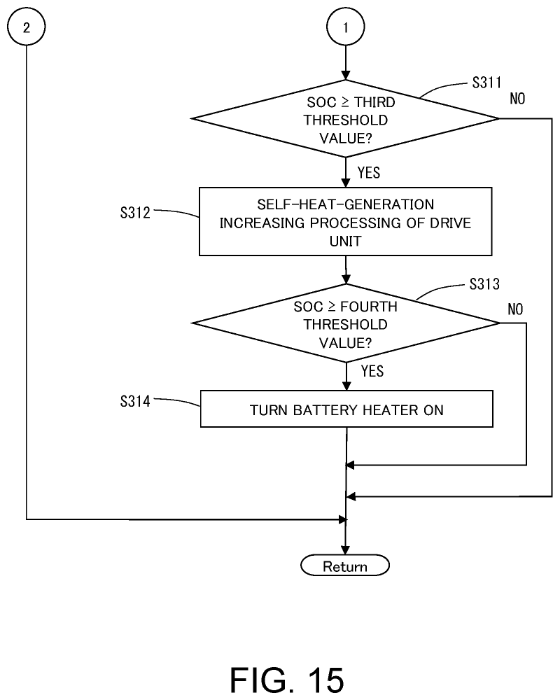

By reference to FIGS. 14 and 15, a further operation of the vehicle cooler 100 will be described. This operation preheats the battery 13 during traveling of the vehicle 200 in a low temperature environment, with the five-way valve 22 being switched to the channel separation mode and the vehicle cabin 201 being heated, as described above by reference to FIG. 4, when the remaining capacity or state of charge (SOC) of the battery 13 is less than the predetermined capacity and rapid charging of the vehicle 200 after stopping is expected.

The controller 90 calculates the SOC of the battery 13 while the vehicle 200 is traveling with the system configuration illustrated in FIG. 4. The SOC may be calculated based on the electric current and voltage of the battery 13, for example. In response to the SOC being smaller than the predetermined capacity, the controller 90 determines YES in step S301 in FIG. 14, and the process proceeds to step S302. In response to the controller 90 determining NO in step S301, the process returns to step S301 for standby.

In step S302 in FIG. 14, the controller 90 determines whether there is a possibility that rapid charging is to be performed after stopping of the vehicle 200. This determination may be performed based on whether the charging history of the vehicle 200 includes an event in which rapid charging was performed after stopping, for example. In response to the controller 90 determining YES in step S302 in FIG. 14, the process proceeds to step S303. In response to determination NO in step S302, it is determined that there is no possibility that rapid charging is performed after stopping and preheating of the battery 13 is not necessary, and the process is terminated.

In step S303, the controller 90 determines whether there is a cooling request for the drive unit 10. When there is a cooling request, it is necessary to cool the refrigerant by the driving system radiator (DSR) 14 to thereby cool the drive unit 10 with the five-way valve 22 remaining switched to the channel separation mode, as illustrated in FIG. 4. In this case, it is not possible to employ the system configuration that allows preheating of the battery 13. Therefore, in response to determination YES in step S303, the controller 90 terminates the processing without preheating the battery 13.

In response to determination NO in step S303, the process proceeds to step S304 where the controller 90 switches the five-way valve 22 to the serial connection mode. In step S305, the controller 90 switches the three-way control valve 56 to the radiator separation mode. This operation changes the system configuration of the vehicle cooler 100 to the system configuration illustrated in FIG. 6. The flows of the refrigerant, the heating medium, and the refrigerant gas in this configuration are the same as those described above by reference to FIG. 6. This configuration enables a temperature rise of the battery 13 with the amount of heat generated by the drive unit 10.

In step S306, the controller 90 calculates a temperature difference DT between the temperature of the drive unit 10 and the cooling start temperature of the drive unit 10. The cooling start temperature as used herein refers to a temperature of the drive unit 10 at which cooling of the drive unit 10 is necessary. Here, NO has been determined in step S303, and, as described above, the temperature of the drive unit 10 is lower than the cooling start temperature. The controller 90 therefore calculates the temperature difference DT, and selects a technique for preheating the battery 13 in accordance with the temperature difference DT.

As indicated in step S307, in response to the temperature difference DT being equal to or higher than the first threshold value, the controller 90 determines YES and the process proceeds to step S308. In step S308, the controller 90 reduces the duty of an electric oil pump (EOP) of the motor device 11 and the duty of the drive-unit-side water pump 16. This further raises the temperature of the refrigerant in the outlet of the drive unit 10 to thereby enable further preheating of the battery 13.

In response to the temperature difference DT being equal to or higher than a second threshold value that is greater than the first threshold value, as determined in step S309, the controller 90 further determines that the cooling system may be stopped and closes the grille shutter (GS) 80 as indicated in step S310. This prevents the outside air from flowing through the driving system radiator (DSR) 14 and the air-conditioning system radiator (ASR) 53 to enable heating of the refrigerant with the amount of heat from the warming heater 51, the amount of heat from the compressor 57, and the amount of heat from the drive unit 10, thereby allowing further heating of the battery 13 with the heated refrigerant.

In response to determination NO in step S307, the controller 90 does not reduce the duties of the EOP and the drive unit-side water pump 16 or close the grille shutter (GS) 80. In response to determination NO in step S309, the controller 90 reduces the duties of the EOP and the drive unit-side water pump 16, but does not close the grille shutter (GS) 80.

The controller 90 then selects a technique for increasing the amount of heat to be transferred to the battery 13 in accordance with the SOC value of the battery 13. In response to the SOC being equal to or higher than a third threshold value, the controller 90 determines YES in step S311 in FIG. 15, and the process proceeds to step S312 in FIG. 15. In step S312, the battery 13 may be preheated by, for example, increasing the current flowing into the motor device 11 to raise the temperature of the motor device 11, for example, thereby increasing self-heating of the drive unit 10 and raising the temperature of the refrigerant. Here, the third threshold value is smaller than the predetermined capacity in step S301.

In step S313, in response to the SOC being equal to or higher than a fourth threshold value that is higher than the third threshold value and lower than the predetermined capacity, the controller 90 determines YES, and the process proceeds to step S314 to turn the battery heater 15 ON.

In response to determination NO in step S311 in FIG. 15, the controller 90 does not increase self-heating of the drive unit 10 nor turn the battery heater 15 ON. In response to determination NO in step S313 in FIG. 15, the controller 90 increases self-heating of the drive unit 10, but does not turn the battery heater 15 ON.

In this manner, the controller 90 selects a technique for the temperature rise of the battery 13 in accordance with the temperature state of the drive unit 10 and the SOC of the battery 13 to enable effective preheating of the battery 13.

As described above, the vehicle cooler 100 enables a previous temperature rise of the battery 13 during traveling of the vehicle 200, thereby allowing rapid charging of the battery 13 immediately after stopping of the vehicle 200.

1. A vehicle cooler configured to cool a drive unit that drives a vehicle and a battery that supplies electric power to the drive unit, the vehicle cooler comprising:
a cooling channel connecting the drive unit and the battery in series to allow a refrigerant to flow through the drive unit and the battery, wherein
the battery is connected downstream of the drive unit.

2. The vehicle cooler as defined in claim 1, wherein
the drive unit comprises a motor for vehicle driving and a power control unit configured to regulate electric power to be supplied to the motor.

3. The vehicle cooler as defined in claim 2, comprising:
a first bypass channel connected to the cooling channel to allow the refrigerant to flow through the battery while bypassing the drive unit;
a first switching valve configured to switchably allow the refrigerant to pass through the first bypass channel or through the drive unit;
an air-conditioner configured to air-condition a vehicle cabin;
a heat exchanger configured to perform heat exchange with the air-conditioner to heat the refrigerant flowing through the cooling channel; and
a controller configured to adjust operation of the first switching valve, the air-conditioner, and the drive unit, wherein
in response to a temperature of the drive unit being lower than a first predetermined temperature, the controller is configured to switch the first switching valve to allow the refrigerant to flow through the first bypass channel, and drive the air-conditioner to heat the refrigerant by the air-conditioner and the heat exchanger to raise a temperature of the battery with the refrigerant that is heated.

4. The vehicle cooler as defined in claim 3, wherein
in response to the temperature of the drive unit being equal to or higher than the first predetermined temperature, the controller is configured to switch the first switching valve to allow the refrigerant to flow through the drive unit, and drive the air-conditioner and the drive unit to heat the refrigerant by the air-conditioner, the heat exchanger, and the drive unit to raise the temperature of the battery with the refrigerant that is heated.

5. The vehicle cooler as defined in claim 2, comprising:
a second bypass channel connected between the drive unit and the battery to allow the refrigerant to flow while bypassing the battery;
a second switching valve configured to switchably allow the refrigerant to flow through the battery or through the second bypass channel;
an air-conditioner configured to air-condition a vehicle cabin;
a heat exchanger configured to perform heat exchange with the air-conditioner to heat the refrigerant flowing through the cooling channel; and
a controller configured adjust operation of the second switching valve, the air-conditioner, and the drive unit, wherein
in response to a temperature of the drive unit being lower than a second predetermined temperature while the vehicle is stopped, the controller is configured to switch the second switching valve to allow the refrigerant to flow through the second bypass channel, and drive the air-conditioner to heat the refrigerant by the air-conditioner and the heat exchanger to raise the temperature of the drive unit with the refrigerant that is heated.

6. The vehicle cooler as defined in claim 3, comprising:
a second bypass channel connected between the drive unit and the battery, the second bypass channel configured to allow the refrigerant to flow while bypassing the battery;
a second switching valve configured to switchably allow the refrigerant to flow through the battery or through the second bypass channel;
an air-conditioner configure to air-condition a vehicle cabin;
a heat exchanger configured to perform heat exchange with the air-conditioner to heat the refrigerant flowing through the cooling channel; and
a controller configured adjust operation of the second switching valve, the air-conditioner, and the drive unit, wherein
in response to the temperature of the drive unit being lower than a second predetermined temperature while the vehicle is stopped, the controller is configured to switch the second switching valve to allow the refrigerant to flow through the second bypass channel, and drive the air-conditioner to heat the refrigerant by the air-conditioner and the heat exchanger to raise the temperature of the drive unit with the refrigerant that is heated.

7. The vehicle cooler as defined in claim 4, comprising:
a second bypass channel connected between the drive unit and the battery, the second bypass channel configured to allow the refrigerant to flow while bypassing the battery;
a second switching valve configured to switchably allow the refrigerant to flow through the battery or through the second bypass channel;
an air-conditioner configured to air-condition a vehicle cabin;
a heat exchanger configured to perform heat exchange with the air-conditioner to heat the refrigerant flowing through the cooling channel; and
a controller configured adjust operation of the second switching valve, the air-conditioner, and the drive unit, wherein
in response to the temperature of the drive unit being lower than a second predetermined temperature while the vehicle is stopped, the controller is configured to switch the second switching valve to allow the refrigerant to flow through the second bypass channel, and drive the air-conditioner to heat the refrigerant by the air-conditioner and the heat exchanger to raise the temperature of the drive unit with the refrigerant that is heated.

8. The vehicle cooler as defined in claim 5, wherein
the drive unit, the air-conditioner, and the heat exchanger are housed within a front compartment of the vehicle,
the vehicle cooler comprises a grille shutter configured to open or close an opening of the front compartment, and
in response to the temperature of the drive unit being lower than the second predetermined temperature while the vehicle is stopped, the controller is configured to close the grille shutter.

9. The vehicle cooler as defined in claim 6, wherein
the drive unit, the air-conditioner, and the heat exchanger are housed within a front compartment of the vehicle,
the vehicle cooler comprises a grille shutter configured to open or close an opening of the front compartment, and
in response to the temperature of the drive unit being lower than the second predetermined temperature while the vehicle is stopped, the controller is configured to close the grille shutter.

10. The vehicle cooler as defined in claim 7, wherein
the drive unit, the air-conditioner, and the heat exchanger are housed within a front compartment of the vehicle,
the vehicle cooler comprises a grille shutter configured to open or close an opening of the front compartment,
in response to the temperature of the drive unit being lower than the second predetermined temperature while the vehicle is stopped, the controller is configured to close the grille shutter.

11. The vehicle cooler as defined in claim 5, wherein
in response to the temperature of the drive unit being equal to or higher than the second predetermined temperature, the controller is configured to switch the second switching valve to allow the refrigerant to flow through the battery, and drive the air-conditioner and the drive unit to heat the refrigerant by the air-conditioner, the heat exchanger, and the drive unit, to raise the temperature of the battery with the refrigerant that is heated.

12. The vehicle cooler as defined in claim 6, wherein
in response to the temperature of the drive unit being equal to or higher than the second predetermined temperature, the controller is configured to switch the second switching valve to allow the refrigerant to flow through the battery and drive the air-conditioner and the drive unit to heat the refrigerant by the air-conditioner, the heat exchanger, and the drive unit, to raise the temperature of the battery with the refrigerant that is heated.

13. The vehicle cooler as defined in claim 7, wherein
in response to the temperature of the drive unit being equal to or higher than the second predetermined temperature, the controller is configured to switch the second switching valve to allow the refrigerant to flow through the battery and drive the air-conditioner and the drive unit to heat the refrigerant by the air-conditioner, the heat exchanger, and the drive unit, to raise the temperature of the battery with the refrigerant that is heated.

14. The vehicle cooler as defined in claim 8, wherein
in response to the temperature of the drive unit being equal to or higher than the second predetermined temperature, the controller is configured to switch the second switching valve to allow the refrigerant to flow through the battery and drive the air-conditioner and the drive unit to heat the refrigerant by the air-conditioner, the heat exchanger, and the drive unit, to raise the temperature of the battery with the refrigerant that is heated.

15. The vehicle cooler as defined in claim 9, wherein
in response to the temperature of the drive unit being equal to or higher than the second predetermined temperature, the controller is configured to switch the second switching valve to allow the refrigerant to flow through the battery and drive the air-conditioner and the drive unit to heat the refrigerant by the air-conditioner, the heat exchanger, and the drive unit, to raise the temperature of the battery with the refrigerant that is heated.

16. The vehicle cooler as defined in claim 2, wherein
the cooling channel comprises a drive unit return channel that allows the refrigerant to return to the drive unit and a battery return channel that allows the refrigerant to return to the battery,
the vehicle cooler further comprises:
a third switching valve configured to switch a connection mode regarding connection of the drive unit return channel and the battery return channel, between a serial connection mode in which the drive unit and the battery are connected in series, with the battery being downstream of the drive unit, to allow the refrigerant to flow through the drive unit and the battery, and a channel separation mode in which the battery return channel and the drive unit return channel are separated;
an air-conditioner configured to air-condition a vehicle cabin;
a heat exchanger that performs heat exchange with the air-conditioner to heat the refrigerant that flows through the cooling channel; and
a controller configured to adjust operation of the air-conditioner and the drive unit, and
in response to a remaining capacity of the battery being equal to or lower than a predetermined capacity during traveling of the vehicle, the controller is configured to switch the third switching valve to the serial connection mode, drive the air-conditioner and heat the refrigerant by the air-conditioner, the heat exchanger, and the drive unit, and raise the temperature of the battery with the refrigerant that is heated.

17. The vehicle cooler as defined in claim 16, wherein
the drive unit, the air-conditioner, and the heat exchanger are housed within a front compartment of the vehicle,
the vehicle cooler comprises a grille shutter configured to open or close an opening of the front compartment, and
the controller is configured to calculate a temperature difference between the temperature of the drive unit and a cooling start temperature at which cooling of the drive unit is necessary, and close the grille shutter in response to the temperature difference being equal to or higher than a predetermined threshold value.

18. The vehicle cooler as defined in claim 2, wherein
the cooling channel comprises a drive unit return channel that allows the refrigerant to return to the drive unit and a battery return channel that allows the refrigerant to return to the battery,
the vehicle cooler further comprises:
a third switching valve configured to switch a connection mode regarding connection of the drive unit return channel and the battery return channel, between a serial connection mode in which the drive unit and the battery are connected in series, with the battery being downstream of the drive unit, to allow the refrigerant to flow through the drive unit and the battery, and a channel separation mode in which the battery return channel and the drive unit return channel are separated; and
a controller configured to adjust operation of the third switching valve, and
the controller is configured to switch the third switching valve to the serial connection mode to constitute the cooling channel that connects the drive unit and the battery in series.

19. The vehicle cooler as defined in claim 5, wherein
the cooling channel comprises a drive unit return channel that allows the refrigerant to return to the drive unit and a battery return channel that allows the refrigerant to return to the battery,
the vehicle cooler further comprises a third switching valve configured to switch a connection mode regarding connection of the drive unit return channel and the battery return channel, between a serial connection mode in which the drive unit and the battery are connected in series, with the battery being downstream of the drive unit, to allow the refrigerant to flow through the drive unit and the battery, and a channel separation mode in which the battery return channel and the drive unit return channel are separated,
the controller is configured to adjust operation of the third switching valve, and
the controller is configured to switch the third switching valve to the serial connection mode to form the cooling channel in which the drive unit and the battery are connected in series.

20. The vehicle cooler as defined in claim 11, wherein
the cooling channel comprises a drive unit return channel that allows the refrigerant to return to the drive unit and a battery return channel that allows the refrigerant to return to the battery,
the vehicle cooler further comprises a third switching valve configured to switch a connection mode regarding connection of the drive unit return channel and the battery return channel, between a serial connection mode in which the drive unit and the battery are connected in series, with the battery being downstream of the drive unit, to allow the refrigerant to flow through the drive unit and the battery, and a channel separation mode in which the battery return channel and the drive unit return channel are separated,
the controller is configured to adjust operation of the third switching valve, and
the controller is configured to switch the third switching valve to the serial connection mode to form the cooling channel that connects the drive unit and the battery in series.
